(19) United States
(12) Patent Application Publication
(10) Pub. No.: US 2026/0039164 A1
(43) Pub. Date: Feb. 5, 2026

(54) COIL BODY, ARMATURE AND ROTARY ELECTRIC MACHINE

(71) Applicant: DENSO CORPORATION, Kariya-city (JP)

(72) Inventors: Yusuke Tateishi, Kariya-city (JP); Shinji Makita, Kariya-city (JP); Keisuke Koide, Kariya-city (JP); Yuji Hayashi, Kariya-city (JP)

(73) Assignee: DENSO CORPORATION, Kariya-city (JP)

(21) Appl. No.: 19/357,395

(22) Filed: Oct. 14, 2025

Related U.S. Application Data
(63) Continuation of application No. PCT/JP2024/010534, filed on Mar. 18, 2024.

(30) Foreign Application Priority Data
Apr. 14, 2023 (JP) 2023-066640

(51) Int. Cl. H02K 3/04; H02K 1/12

(52) U.S. Cl. CPC H02K 3/04; H02K 1/12

(57) ABSTRACT

The coil body is provided with a substrate and a plurality of coil parts. The substrate is formed in a shape extending in a radial direction using an insulation material and stacked in an axial direction. The plurality of coil parts includes a plurality of conductor parts each formed on the substrate using a conductive material, arranged along a circumferential direction. The conductor parts formed on one layer of the substrate and the conductor parts formed on other layers of the substrate are alternately arranged in the circumferential direction. The plurality of conductor parts formed on one layer of the substrate and the plurality of conductor parts formed on other layers of the substrate are overlapped in the circumferential direction.

### CROSS-REFERENCE OF RELATED APPLICATIONS

This application is the U.S. bypass application of International Application No. PCT/JP/2024/010534 filed on Mar. 18, 2024, which designated the U.S. and claims priority to Japanese Patent Application 2023-066640 filed on Apr. 14, 2023, and the contents of both of these are incorporated herein by reference.

### BACKGROUND

### Technical Field

The present disclosure relates to a coil body, an armature and a rotary electric machine.

### Description of the Related Art

A coil for a rotary electric machine is known, which is used for a rotary electric machine such as a motor or the like. For example, a coil for a rotary electric machine disclosed by one patent literature is provided with a coil plate element having a plurality of layers formed in a disk shape.

### SUMMARY

According to a first aspect of the present disclosure, a coil body is provided with a base member formed in a shape extending in a radial direction using an insulation material, stacked in an axial direction; a plurality of conductor parts each formed on the base material using a conductive material, arranged along a circumferential direction; and a plurality of coil parts configured such that the conductor parts formed on one layer of the base member and the conductor parts formed on other layers of the base member are alternately arranged in the circumferential direction, and the plurality of conductor parts formed on one layer of the base member and the plurality of conductor parts formed on other layers of the base member are overlapped in the circumferential direction.

### BRIEF DESCRIPTION OF THE DRAWINGS

The above-described objects and other objects, features and advantages of the p resent disclosure will be clarified further by the following detailed description with refer ence to the accompanying drawings. The drawings are:

FIG. 1 is a perspective view showing a motor according to a first embodiment in which a part of the motor is cutoff;

FIG. 2 is a disassembled perspective view showing a disassembled motor according to the first embodiment in which a part of components is cutoff;

FIG. 3 is a disassembled perspective view showing a disassembled coil body in which a part of the coil body is cutoff;

FIG. 4 is a plan view schematically showing the coil body;

FIG. 5 is an explanatory diagram showing a star-connection;

FIG. 6 is a plan view schematically showing one substrate and a coil part or the like formed on the one substrate;

FIG. 7 is a cross-sectional view in a coil part according to the first embodiment, showing a cross section of a part of a substrate in a specific layer and a coil part formed on the substrate;

FIG. 8 is a cross-sectional view in a coil part according to the first embodiment, showing a cross section of a part of substrates in a plurality of layers and a coil part formed on each of substrates in a plurality of layers;

FIG. 9 is a disassembled perspective view showing a disassembled coil body of a motor according to a second embodiment in which a part of the coil body is cutoff;

FIG. 10 is a plan view schematically showing a coil body of a motor according to a second embodiment;

FIG. 11 is a plan view schematically showing one substrate of a motor according to the second embodiment and a coil part or the like formed on the one substrate;

FIG. 12 is a cross-sectional view in a coil part according to the second embodiment, showing a cross section of a part of a substrate in a specific layer and a coil part formed on the substrate;

FIG. 13 is a cross-sectional view in a coil part according to the second embodiment, showing a cross section of a part of substrates in a plurality of layers and a coil part formed on each of substrates in a plurality of layers;

FIG. 14 is a schematic diagram showing a cross section of a stator of a motor according to a third embodiment, sectioned along an axial direction and a circumferential direction;

FIG. 15 is a schematic diagram showing a cross section of a stator of a motor according to a fourth embodiment, sectioned along an axial direction and a circumferential direction;

FIG. 16 is a schematic diagram showing a cross section of a stator of a motor according to a fifth embodiment, sectioned along an axial direction and a circumferential direction;

FIG. 17 is a schematic diagram showing a cross section of a stator of a motor according to a sixth embodiment, sectioned along an axial direction and a circumferential direction;

FIG. 18 is a schematic diagram showing a cross section of a stator of a motor according to a seventh embodiment, sectioned along an axial direction and a circumferential direction;

FIG. 19 is a schematic diagram showing a cross section of a stator of a motor according to an eighth embodiment, sectioned along an axial direction and a circumferential direction;

FIG. 20 is a plan view schematically showing a coil body of a motor according to a ninth embodiment;

FIG. 21 is a plan view schematically showing a coil body of a motor according to a tenth embodiment;

FIG. 22 is a schematic diagram showing a cross section of a coil body of a motor according to a tenth embodiment, sectioned along an axial direction and a circumferential direction;

FIG. 23 is a plan view schematically showing one substrate of a coil body of a motor according to the tenth embodiment and a coil part and a soft magnetic member or the like formed on the one substrate;

FIG. 24 is a schematic diagram showing a cross section of one substrate of a coil body of a motor according to the tenth embodiment and a coil part and a soft magnetic member or the like formed on the one substrate, sectioned along an axial direction and a circumferential direction;

FIG. 25 is a plan view schematically showing a stator of a motor according to an eleventh embodiment;

FIG. 26 is a schematic diagram showing a cross section of a stator of a motor according to the eleventh embodiment, sectioned along an axial direction and a circumferential direction;

FIG. 27 is a plan view schematically showing one substrate of a coil body of a motor according to the eleventh embodiment and a coil part or the like formed on the one substrate;

FIG. 28 is a plan view schematically showing a coil body of a motor according to a twelfth embodiment;

FIG. 29 is a plan view schematically showing one substrate of a coil body of a motor according to the twelfth embodiment and a coil part or the like formed on the one substrate;

FIG. 30 is a schematic diagram showing a cross section of a coil body of a motor according to a thirteenth embodiment, sectioned along an axial direction and a circumferential direction;

FIG. 31 is a schematic diagram showing a cross section of a coil body of a motor according to a fourteenth embodiment, sectioned along an axial direction and a circumferential direction;

FIG. 32 is a schematic diagram showing a cross section of a coil body of a motor according to a fifteenth embodiment, sectioned along an axial direction and a circumferential direction;

FIG. 33 is a schematic diagram showing a cross section of a coil body of a motor according to a sixteenth embodiment, sectioned along an axial direction and a circumferential direction;

FIG. 34 is a schematic diagram showing a cross section of a coil body of a motor according to a seventeenth embodiment, sectioned along an axial direction and a circumferential direction;

FIG. 35 is a schematic diagram showing a cross section of a coil body of a motor according to a eighteenth embodiment, sectioned along an axial direction and a circumferential direction;

FIG. 36 is a plan view showing only a coil part formed on one side surface of a substrate in one layer constituting a coil body of a motor according to a nineteenth embodiment;

FIG. 37 is a partial cross-sectional perspective view showing a substrate in one layer constituting a part of a coil body of a motor according to a twentieth embodiment and a coil part formed on the substrate; and

FIG. 38 is a perspective view schematically showing a coil body of a motor acco rding to a twenty first embodiment.

### DETAILED DESCRIPTION OF PREFERRED EMBODIMENTS

Patent literature JP-A-2008-061357 discloses a coil for a rotary electric machine used for a rotary electric machine such as a motor or the like. The coil for a rotary electric machine disclosed by the above patent literature is provided with a coil plate element having a plurality of layers formed in a disk shape. The coil plate element includes a predetermined wiring pattern formed thereon. Moreover, respective coil plate elements are joined at an inner peripheral part and an outer peripheral part while being separated at an intermediate part, thereby constituting a coil plate having a predetermined coil wiring pattern.

The rotary electric machine is required to reduce its size and to have higher efficiency and higher torque. In this respect, configuration disclosed by the above-described patent literature is still required to be improved.

Hereinafter, with reference to the drawings, embodiments of the present disclosure will be described.

### Configuration of a Motor According to First Embodiment

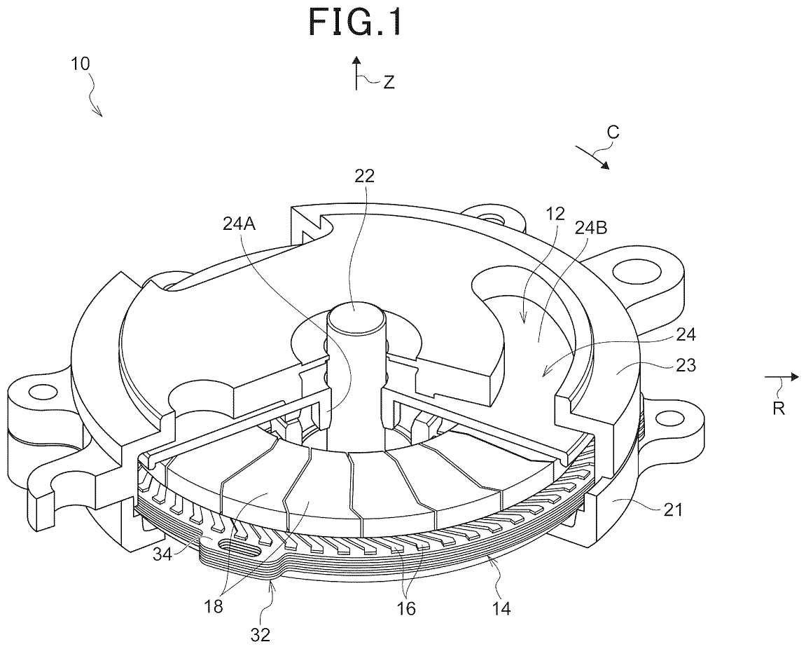

With reference to FIGS. 1 to 8, a configuration of a motor 10 according to a first embodiment of the present disclosure will be described. In the drawings, an arrow-Z direction, an arrow R direction and an arrow C direction indicate a rotational axis direction in one side, an outer side in a rotational radial direction and one side in a rotational circumferential direction of a rotor 12 respectively, which will be described later. Hereinafter, when simply describing an axis direction, a radial direction and a circumferential direction, these indicate a rotary axis direction, a rotary radial direction and a rotary circumferential direction of the rotor 12 unless otherwise specified. The motor 10 and motors in the respective embodiments which will be described later are examples of a rotary electric machine.

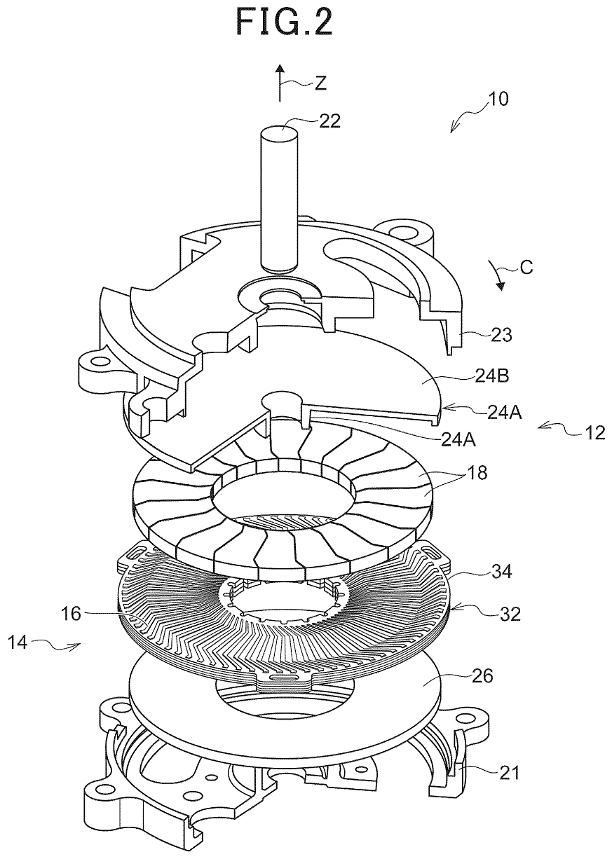

As shown in FIGS. 1 and 2, the motor 10 is an axial gap type brushless motor in which a rotor 12 as a rotor, an armature and a stator 14 as a stator are arranged in an axial direction. Note that FIGS. 1 and 2 illustrate a motor 10 or the like as an example where some of the portions may be different from those in the latter description, for example, the number of coil parts 16, the number of magnets and detailed shape are different therebetween.

The rotor 12 is configured to have a rotary shaft 22 rotatably supported by a pair of bearing (not shown), a rotor core 24 fixed to the rotary shaft 22, a plurality of magnets 18 fixed on a surface in the other side of the rotor core 24 with respect to the axial direction. Note that the pair of bearings are each supported by a frame 21 and a frame end 23. A stator 14 or the like is accommodated between the frame 21 and the frame end 23.

The rotor 24 is provided with a first cylindrical part 24A formed in a cylindrical shape to which the rotary shaft 22 is fixed by a press fitting, a disk part 24B extending radially outside from an end part in one side thereof with respect to the axial direction. The disk part 24B is formed in a cylindrical shape of which the axial direction is its thickness direction. The plurality of magnets 18 (described later) are fixed to a surface of the disk part 24B in the other side thereof with respect to the axial direction.

The plurality of magnets 18 is formed using magnetic compounds in which an intrinsic coercive force Hc is 400 [kA/m] or more and a residual magnetic flux density Br is 1.0 [T] or more. For example, the magnets 18 are formed using magnetic compounds such as NdFe₁₁TiN, Nd₂Fe₁₄B, Sm₂Fe₁₇N₃, FeNi. Further, the plurality of magnets 18 are fixed to a surface of the disk part 24B of the rotor core 24 in the other side thereof with respect to the axial direction. A magnet 18 in which a surface in the other side in the axial direction is N-pole and a magnet 18 in which a surface in the other side in the axial direction is S-pole are alternately arranged in the circumferential direction. Note that the number of magnets 18 may be appropriately set taking an output power and the like required for the motor 10.

The stator 14 is provided with a stator core 26 formed in an annular shape as an armature core and a coil body 32 arranged along a surface of the stator core 26 in one side in an axial direction (axial one side). The stator core 14 is configured to have a teeth-less structure in which a part of the stator core 26 is not provided between coil parts 16 that constitute the coil body 32.

The stator core 26 is formed using a soft magnetic material such as steel. The stator core 26 is formed in a plate-shape such that of which the thickness direction corresponds to the axial direction, and formed in an annular shape when viewed in the axial direction. The stator core 26 is disposed coaxially with the rotor 12 such that the center position of the stator core 26 in the radial direction and the center position of the plurality of magnets 18 fixed to the rotor core 24 are coincident in the radial direction.

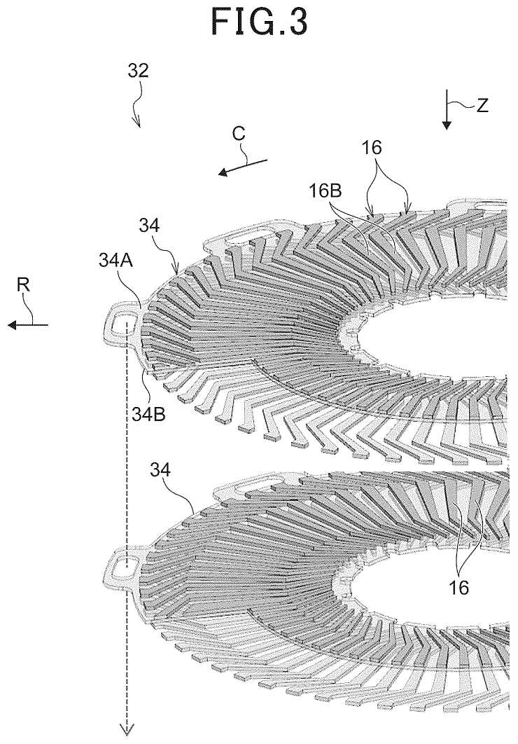

As shown in FIG. 3, the coil body 32 is configured to include a plurality of substrates 34 as a base member formed in a sheet shape using an insulation material and a plurality of coil parts 16 each formed on the plurality of substrates 34.

The substrate 32 is formed in a plate-shape of which the thickness direction corresponds to the axial direction and formed in an annular shape when viewed in the axial direction. Note that the substrate 34 may be a flexible substrate capable of being bent in the thickness direction or may be a substrate which cannot be bent in the thickness direction. According to the coil body 32 of the present embodiment, a plurality of substrates 32 are stacked in the axial direction.

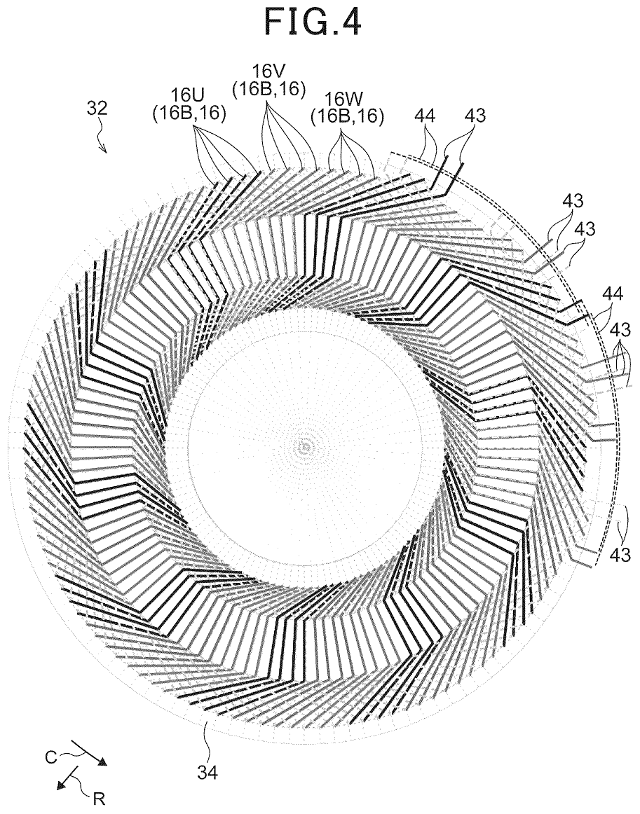

As shown in FIGS. 3 and 4, the plurality of coil parts 16 are formed on each of the plurality of substrates 34. Then, the plurality of substrates 34 are stacked in the axial direction, whereby the plurality of coil parts 16 are arranged at a predetermined positions in the circumferential direction and the axial direction.

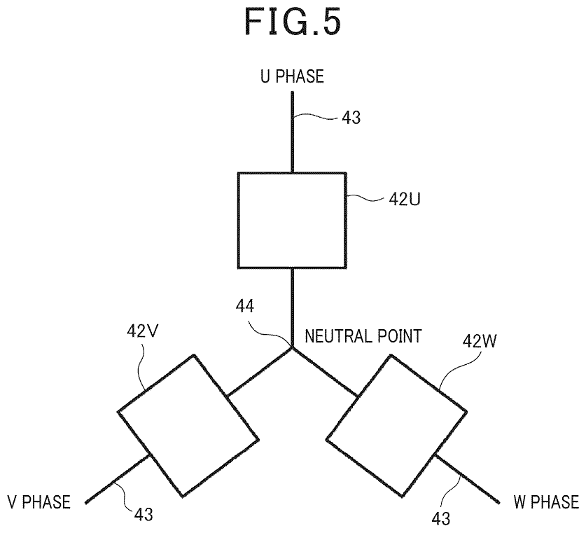

As shown in FIG. 5, the plurality of coil parts 16 that constitute the U-phase (i.e. U phase coil group 42U), the plurality of coil parts 16 that constitute the V-phase (i.e. V phase coil group 42V), and the plurality of coil parts 16 that constitute the W-phase (i.e. W phase coil group 42W) are connected as a star-connection. That is, an end part opposite to an input part 43 in the U-phase coil group 42U, to be connected to a power source, an end part opposite to an input part 43 in the V-phase coil group 42V, to be connected to a power source, and an end part opposite to an input part 43 in the W-phase coil group 42W, to be connected to a power source, are connected to each other at a neutral point 44.

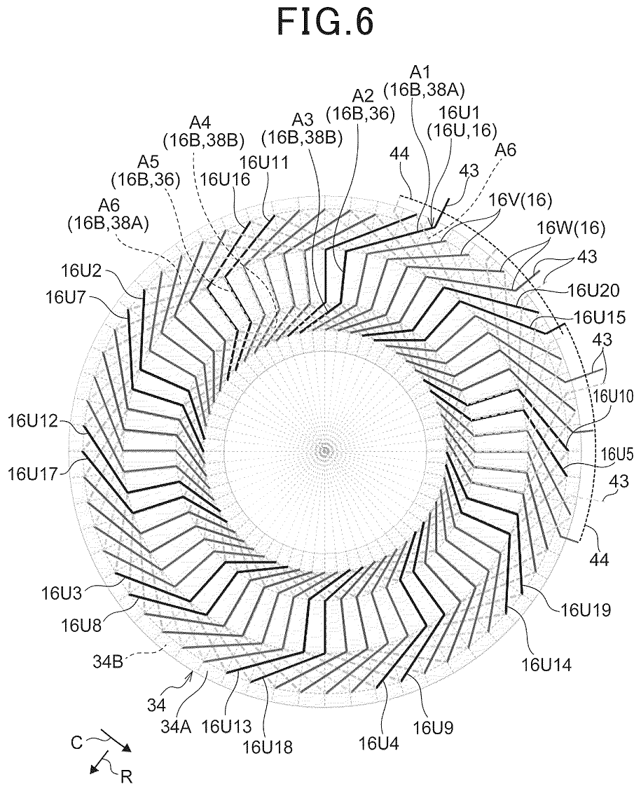

In FIG. 6, a substrate 34 in the first-layer and the plurality of coil parts 16 formed on the substrate 34 in the first layer are shown. Here, 20 coil parts 16 that constitute the U-phase, 20 coil parts 16 that constitute the V-phase, and 20 coil parts 16 that constitute the W-phase are formed on the first layer substrate 34. In the following description, the coil parts 16 that constitute the U-phase are sometimes referred to as coil parts 16U, the coil parts 16 that constitute the V-phase are sometimes referred to as coil parts 16V, and the coil parts 16 that constitute the W-phase are sometimes referred to as coil parts 16W. Further, in the following description, 20 coil parts 16 that constitute the U-phase are sometimes each referred to as coil part 16U1 to coil part 16U20. Also, 20 coil parts 16 that constitute the V-phase are sometimes each referred to as coil part 16V1 to coil part 16V20. Moreover, 20 coil parts 16 that constitute the W-phase are sometimes each referred to as coil part 16W1 to coil part 16W20.

In more detail, the coil part 16U1 is provided with a first extending part A1 inclined radially inside towards circumferential one side and a second extending part A2 inclined radially inside from one end of the first extending part A1 in the circumferential one side. Moreover, the coil part 16U1 is provided with a third extending part A3 inclined radially inside towards circumferential one side from one end of the second extending part A2 opposite to the first extending part A1, and a fourth extending part A4 inclined radially outside towards circumferential one side from one end of the third extending part A3 opposite to the second extending part A2. Furthermore, the coil part 16U1 is provided with a fifth extending part A5 inclined radially outside from one end of the fourth extending part A4 opposite to the third extending part A3, and a sixth extending part A6 inclined radially outside from one end of the fifth extending part A5 opposite to the fourth extending part A4. In the following description, the first extending part A1 to the sixth extending part A6 may be sometimes referred to as a conductor part 16B. According to the coil body 32 thus configured, the conductor parts 16B are regularly arranged in the circumferential direction.

Here, the first extending part A1, the second extending part A2 and the third extending part A3 are formed on a surface 34A as a surface in one side of the substrate 34 (surface in the stator core 26 side). Further, the fourth extending part A4, the fifth extending part A5 and the sixth extending part A6 are formed on a surface 34B as a surface in the other side of the substrate 34 (surface opposite to the stator core 26 side). The third extending part A3 and the fourth extending part A4 are electrically connected via a via contact or a through hole (not shown), for example. In FIG. 6, a portion of the coil part 16U1 formed on one side surface 34A of the substrate 34 is indicated by a solid line. Also, a portion of the coil part 16U1 formed on the other side surface 34B of the substrate 34 is indicated by a dotted line.

Moreover, the second extending part A2 and the fifth extending part A5 may be sometimes referred to as a vertical part 36. Also, the first extending part A1 and the sixth extending part A6 may be referred to as an outer coil end part 38A as an one side coil end part, and the third extending part A3 and the fourth extending part A4 may be referred to as an inner coil end part 38B as the other side coil end part. Then, since one coil part 16 has the first extending part A1 to the sixth extending part A6, a shape of one coil part 16U1 when viewed in the thickness direction of the substrate 34 shows a substantial V-shape (U-shape) in which a radially outside portion of the substrate 34 is opened and a radially inside portion thereof is closed.

Moreover, other coil parts 16U2 to 16U20 that constitute the U-phase are also configured similarly to those in the col part 16U1. In other words, all of the coil parts 16 that constitute the U-phase have substantially the same configuration.

The coil part 16U2 connected to the coil part 16U1 is disposed to one circumferential side relative to the coil part 16U1. Further, the coil part 16U3 connected to the coil part 16U2 is disposed to one circumferential side relative to the coil part 16U2. Moreover, the coil part 16U4 connected to the coil part 16U3 is disposed to one circumferential side relative to the coil part 16U3. Similarly, the coil part 16U5 connected to the coil part 16U4 is disposed to one circumferential side relative to the coil part 16U4. Here, the sixth extending part A6 of the coil part 16U5 and the first extending part U1 of the coil part 16U1 cross each other when viewed in the axial direction. Thus, an end part of the coil part 16U5 in a portion connected to the coil part 16U6 is positioned in a circumferential one side with respect to an end part of the coil part 16U1 in an input part 43 side.

The coil part 16U6 connected to the coil part 16U5 is disposed to one circumferential side relative to the coil part 16U5, being adjacently positioned to the coil part 16U1 in the circumferential direction. Also, the coil part 16U7 connected to the coil part 16U6 is disposed to one circumferential side relative to the coil part 16U6, being adjacently positioned to the coil part 16U2 in the circumferential direction. Similarly, the coil part 16U8 connected to the coil part 16U7 is disposed in a circumferential one side with respect the coil part 16U7, being adjacently positioned to the coil part 16U3 in the circumferential direction. The coil part 16U9 connected to the coil part 16U8 is disposed in the circumferential one side with respect to the coil part 16U8, being adjacently positioned to the coil part 16U4. The coil part 16U10 connected to the coil part 16U9 is disposed in the circumferential one side with respect to the coil part 16U9, being adjacently positioned to the coil part 16U5. An end part of the coil part 16U10 opposite to the coil part 16U9 is a neutral point 44.

The coil part 16U11 to coil part 16U20 connected in parallel to the coil part 16U1 to coil part 16U10 are configured similarly to the coil part 16U1 to coil part 16U10. The coil part 16U11 to coil part 16U20 are arranged to be offset by 36 degrees in the circumferential one side corresponding to the coil part 16U1 to the coil part 16U10, respectively. Thus, the vertical parts 36 of the coil part 16U11 to the coil part 16U20 and the vertical parts 36 of the coil part 16U1 to the coil part 16U10 are arranged at the same position in the circumferential direction.

Although detailed description using reference symbols in the drawings is omitted, the coil part 16V1 to the coil part 16V20 constituting the V-phase are configured similarly to the coil part 16U1 to the coil part 16U20 that constitute the U-phase. The coil part 16V1 to the coil part 16V20 that constitute the V-phase are arranged to be offset by 12 degrees in the circumferential other side corresponding to the coil part 16U1 to the coil part 16U20 that constitute the U-phase. Moreover, the coil part 16W1 to the coil part 16W20 that constitutes the W-phase are configured similarly to the coil part 16U1 to the coil part 16U20 that constitute the U-phase. The coil part 16W1 to the coil part 16W20 that constitutes the W-phase are arranged to be offset by 12 degrees in the circumferential other side corresponding to the coil part 16V1 to the coil part 16V20 that constitute the V-phase.

The second layer substrate 34 stacked on the first layer substrate 34 and a plurality of coil parts 16 formed on the second layer substrate 34 are configured similarly to the first layer substrate 34 and a plurality of coil parts 16 formed on the first layer substrate 34. According to the present embodiment, a pattern of the plurality of coil parts 16 formed on the first layer substrate 34 matches a pattern of the plurality of coil parts 16 formed on the second layer substrate 34. The plurality of coil parts 16 formed on the second layer substrate 34 are arranged to be offset by 6 degrees in the circumferential other side corresponding to the plurality of coil parts 16 formed on the first layer substrate 34. Then, the first layer substrate 34 and the second layer substrate 34 are stacked in the axial direction, whereby the plurality of coil parts 16 formed on the first layer substrate 34 and the plurality of coil parts 16 formed on the second substrate 34 are arranged at predetermined positions in the circumferential direction and the axial direction.

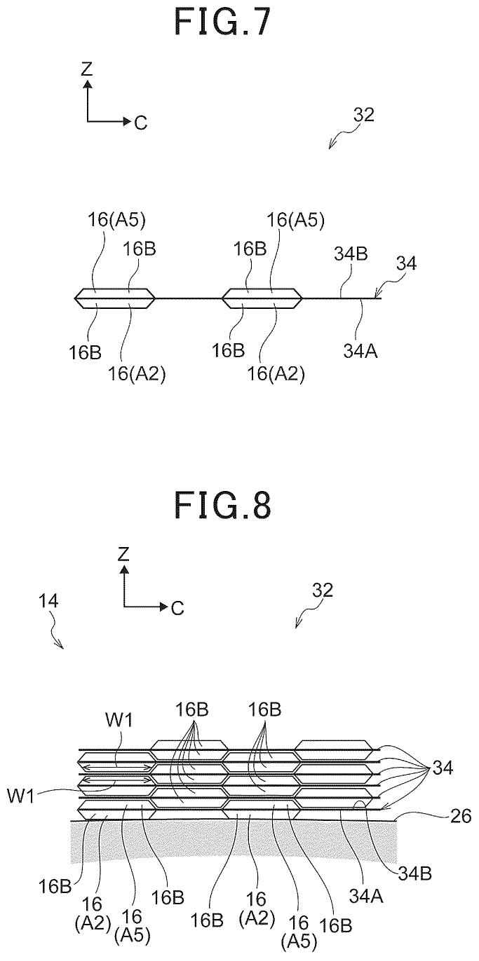

Here, FIG. 4 schematically shows a state where the first layer substrate 34 and the second substrate 34 are stacked. In FIG. 4, respective portions of the coil part 16 disposed between the first layer substrate 34 and the second layer substrate 34 are indicated by a solid line and other portions of the coil part 16 are indicated by a dotted line. As shown in FIG. 4, respective portions of the coil part 16 formed on the first layer substrate 34 and respective portions of the coil part 16 formed on the second layer substrate 34 are alternately arranged along the circumferential direction and overlapped in the circumferential direction. Note that such a configuration will be described later in detail with reference to FIGS. 7 and 8 which are more simplified from FIG. 4.

For the third layer substrate 34 and the fourth layer substrate 34, they are stacked having the same relationship between the first layer substrate 34 and the second layer substrate 34. Moreover, for a configuration having 5 (3 layers) or more substrates 34, they are stacked having the same relationship between the first layer substrate 34 and the second layer substrate 34. The number of stacks of the coil body 32 (the number of stacks of substrates 34) may be appropriately set considering an output or the like required for the motor 10.

FIGS. 7 and 8 show a cross-section of a part of coil body 32 sectioned in the axial direction and the circumferential direction. In more detail, FIG. 7 shows a part of the substrate 34 at a specific layer and a cross-section of a coil part 16 (conductor part 16B) formed on the substrate 34. Further, FIG. 8 shows a part of the substrate 34 having a plurality of layers and a cross-section of coil parts 16 (conductor parts 16B) each formed on each of the plurality of layers of the substrate 34. Note that hatching of the cross-section is omitted in FIGS. 7 and 8. As shown in FIGS. 7 and 8, according to the present embodiment, in a state where one layer of the substrate 34 and other layers of the substrate 34 are stacked in the axial direction, the conductor parts 16B formed on one layer of the substrate 34 and the conductor parts 16B formed on other layers substrate 34 are alternately arranged in the circumferential direction. Also, in a state where one layer substrate 34 and other layer substrates 34 are stacked in the axial direction, a plurality of conductor parts 16B formed on one layer of the substrate 34 and a plurality of conductor parts 16B formed on other layer substrates 34 are overlapped in the circumferential direction. Further, as shown in FIGS. 4, 6, 7 and 8, in a state where one layer substrate 34 and other layers substrates 34 are stacked in the axial direction, the conductor parts 16B (vertical part 36) of the coil parts 16 in the same phase are arranged in the axial direction.

According to the present embodiment, a width dimension W1 in the circumferential direction of the conductor parts 16B formed on one layer substrate 34 becomes smaller towards a substrate 34 in other layers. Further, a width dimension W1 in the circumferential direction of the conductor part 16B formed on the substrate 34 in other layer becomes smaller towards one layer substrate 34.

### Effects and Advantages

Next, effects and advantages of the motor 10 according to the present embodiment will be described.

As shown in FIGS. 1, 2, 4 and 5, according to the motor 10 of the present embodiment, conduction states of a U-phase coil group 42U, a V-phase coil group 42V and a W-phase coil group 42W that constitute a part of the stator 14 are changed, thereby producing a rotating magnetic field. Thus, the rotor 12 rotates.

Here, the coil body 32 is configured including a plurality of substrates 34 and a plurality of coil parts 16 formed on each of the plurality of substrate 34. The plurality of substrates 34 are stacked in the axial direction, whereby the plurality of coil parts 16 are arranged at predetermined positions in the circumferential direction and the axial direction. With this configuration, the size of the coil body 32 can be prevented from increasing in the axial direction. As a result, the size of the motor 10 can be prevented from being increased.

Further, as shown in FIG. 8, in a state where one layer of the substrate 34 and other layers of the substrates 34 are stacked in the axial direction, the conductor parts 16B formed on one layer substrate 34 and the conductor parts 16B formed on the substrates 34 in other layers are alternately arranged along the circumferential direction. Moreover, in a state where one layer of the substrate 34 and other layers of the substrate 34 are stacked in the axial direction, a plurality of conductor parts 16B formed on one layer substrate 34 and a plurality of conductor parts 16B formed on substrate 23 in other layers are overlapped in the circumferential direction. Thus, according to the coil body 32 of the motor 10 of the present embodiment, the space factor can be increased. As a result, high efficiency and high torque of the motor 10 can be accomplished while preventing the size of the motor 10 from increasing.

According to the coil body 32 of the motor 10 of the present embodiment, intervals between conductor parts 16B on the substrate 34 in the circumferential direction can be set larger. Thus, when a manufacturing method is employed in which a conductor part 16B is formed on the substrate 34 by performing an etching process for example, limitation of the thickness of the conductor part 16B can be relaxed. Thus, the thickness of the conductor part 16B can be increased, whereby the space factor of the coil body 32 can be improved. Moreover, a configuration in which a conductor part 16B formed by a press molding is fixed on the substrate 34 may be employed. In the case where the conductor part 16B is formed by the press molding, in order to ensure the punch strength of a die that forms the conductor part 16B, narrow gaps between conductor parts adjacently positioned in the circumferential direction are limited and it may be necessary to sacrifice the space factor. However, according to the present embodiment, since a configuration is employed in which intervals between conductor parts 16B on the substrate 34 in the circumferential direction is set to be wider, such a problem is unlikely to arise.

Moreover, according to the present embodiment, a width dimension W1 in the circumferential direction of the conductor parts 16B formed on one layer substrate 34 becomes smaller towards substrate 34 in other layer. Further, a width dimension W1 in the circumferential direction of the conductor part 16B formed on the substrate 34 in another layer becomes smaller towards one layer substrate 34. Thus, when one layer substrate 34 and substrate 34 in other layers are stacked, a plurality of conductor parts 16B formed on the substrate 34 in other layers can readily be arranged between the plurality of conductor parts 16B formed on one layer substrate 34. Moreover, according to the present embodiment, the patterns of the plurality of coil parts 16 formed on respective layers of the substrates 34 are mutually the same. Thus, it is not necessary to set respective patterns of coil parts 16 for respective layers of the substrates 34.

### Second Embodiment

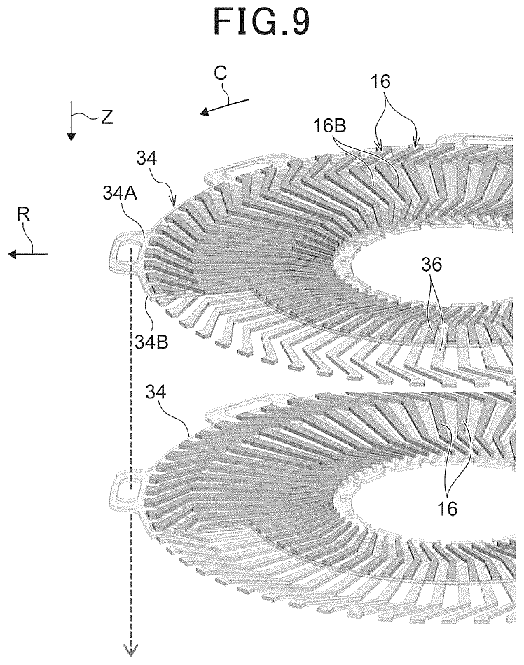

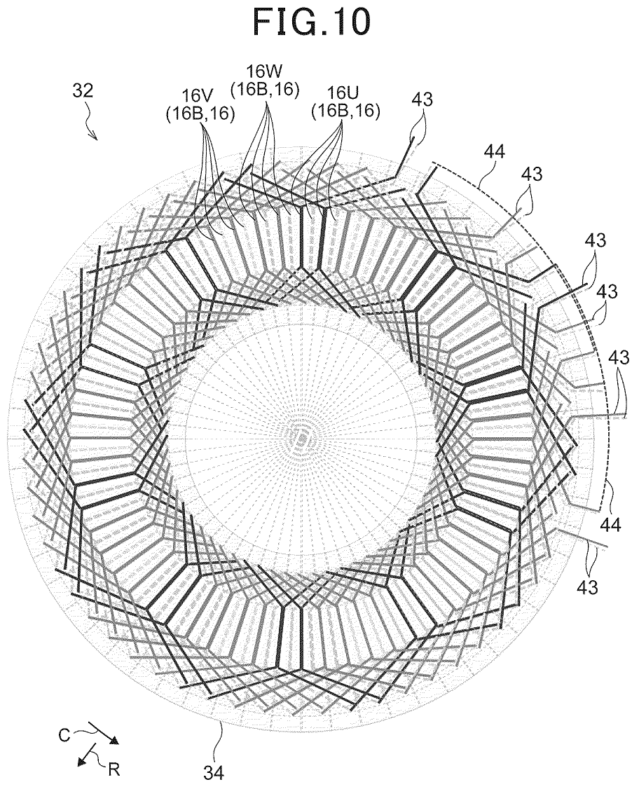

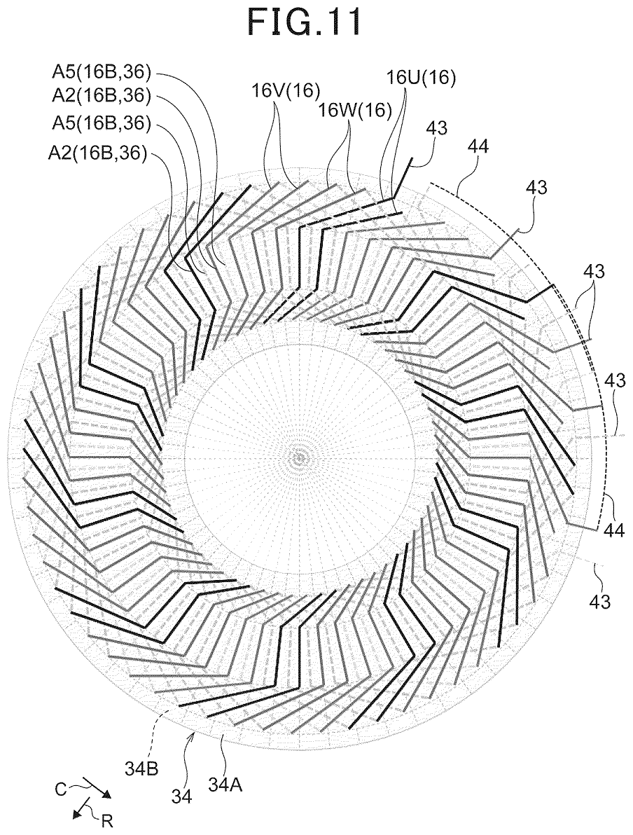

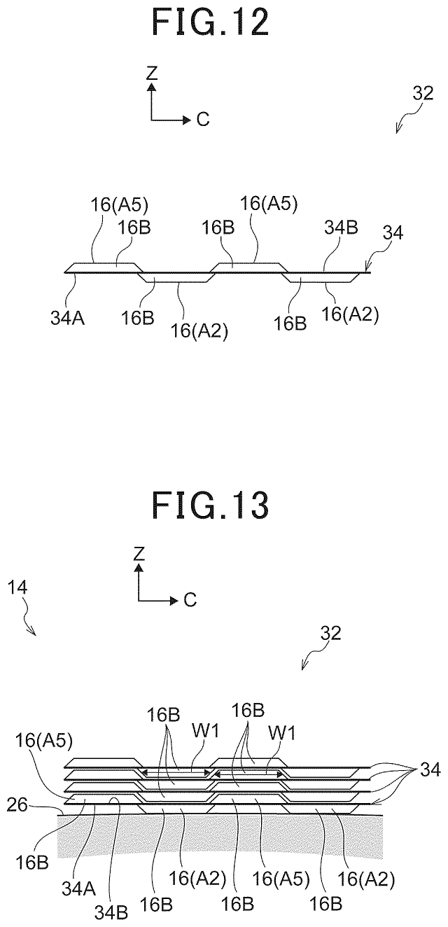

With reference to FIGS. 9 to 13, a motor of the second embodiment will be described. In the motor according to the second embodiment, the same reference symbols as those of the above-described motor 10 are applied to configurations corresponding to above-described motor 10 and the explanation thereof may be omitted.

FIGS. 9, 10, 11 and 12 correspond to FIGS. 3, 4, 6 and 7 respectively as a reference used for describing the motor 10 according to the first embodiment. As illustrated in these drawings, the motor according to the present embodiment is configured similarly to the motor 10 of the above-described motor 10, except that a vertical part 36 formed on one surface 34A of the substrate 34 and a vertical part 36 formed on the other surface 34B of the substrate 34 are arranged to be offset in the circumferential direction.

FIG. 13 corresponds FIG. 8 as a reference used for describing the motor 10 according to the first embodiment. As shown in FIG. 13, in a state where one layer substrate 34 and substrates 34 in other layers are stacked in the radial direction, the conductor parts 16B formed on one layer substrate 34 and the conductor parts 16B formed on the substrate 34 in other layers are alternately arranged along the circumferential direction. Further, in a state where one substrate 34 and the substrates 34 in other layers are stacked in the radial direction, a plurality of conductor parts 16B formed on one layer substrate 34 and a plurality of conductor parts 16B formed on the substrates in other layers are overlapped in the circumferential direction. Thus, also with the coil body 32 of the motor according to the present embodiment, the space factor can be increased similarly to the above-described motor 10.

### Third Embodiment

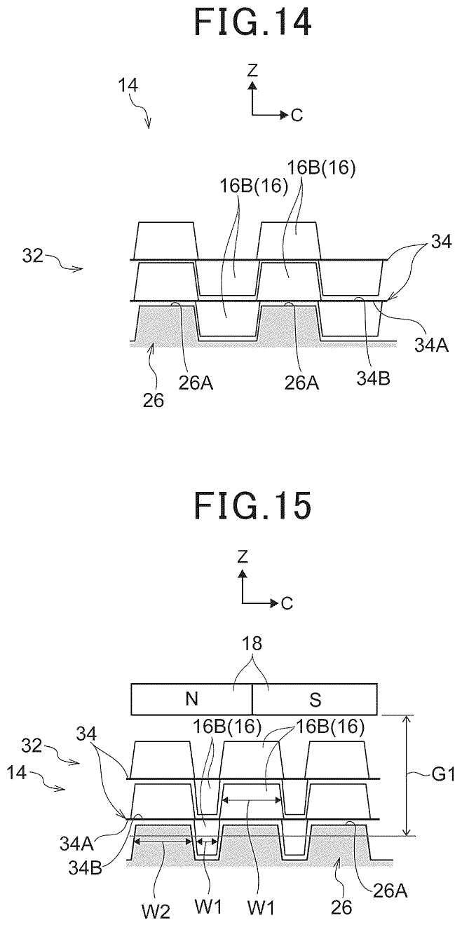

With reference to FIG. 14, a motor according to a third embodiment will be described. In the motor according to the third embodiment, the same reference symbols as those of the above-described motor 10 are applied to configurations corresponding to above-described motor 10 and the explanation thereof may be omitted.

FIG. 14 schematically shows a cross-section of a stator 14 of a motor according to the third embodiment, sectioned along a circumferential direction. As shown in FIG. 14, a configuration of a coil body 32 that constitutes a part of a stator 14 is similar to that of the coil body 32 of the motor according to the above-described second embodiment.

Here, according to the stator 14 of the present embodiment, the conductors 16B formed on a substrate 34 disposed at a layer facing the stator core 26 and a stator core 26 are fitted in a convex-concave shape. In more detail, a plurality of convex fitting parts 26A are formed on a surface of the stator core 26 in the coil body 32 side, protruding towards axial one side. These convex fitting parts 26A are each fitted to a pair of conductor parts 16B formed on the substrate 34 disposed at a layer facing the stator core 26. Thus, the coil body 32 can be fixed to the stator core 26. Further, a plurality of convex fitting parts 26A are able to serve as teeth. Note that the teeth refers to a part of the stator core in which conductive wirings are wound therearound to form a coil around the part of the stator core. Moreover, according to the stator 14 of the motor of the present embodiment, the conductor parts 16B formed on the substrate 34 disposed at a layer facing the stator core 26 are inserted into a portion in an axial one side of the stator core 26, whereby a distance between a surface in an axial one side of the stator core 26 and a surface in an axial one side of the coil body 32 can be prevented from being longer.

### Fourth Embodiment

With reference to FIG. 15, a motor according to the fourth embodiment will be described. In the motor according to the fourth embodiment, the same reference symbols as those of the above-described motor 10 are applied to configurations corresponding to above-described motor 10 and the explanation thereof may be omitted.

FIG. 15 schematically shows a cross-section of a stator 14 of a motor according to the fourth embodiment, sectioned along a circumferential direction. As shown in FIG. 15, the configuration of the stator 14 is similar to the stator 14 of the motor according to the above-described third embodiment except configurations described below.

According to the coil body 32 of a motor of the fourth embodiment, the width dimension W1 in the circumferential direction of the conductor part 16B fitted with the stator core 26 in a convex-concave shape is set to be smaller than the width dimension W1 in the circumferential direction of the conductor part 16B which is not fitted with the stator core 26 in a convex-concave shape. Specifically, the width dimension W1 in the circumferential direction of the conductor part 16B formed on a surface of the substrate 34 in the stator core 26 side is set to be smaller than the width dimension W1 in the circumferential direction of the conductor part 16B formed on a surface of the substrate 34 opposite to the stator core 26 side. Further, the width dimension W2 in the circumferential direction of a convex fitting part 26A is set to be larger than a width dimension in the circumferential direction of a convex fitting part 26A of a motor of the above-described third embodiment. Furthermore, the width dimension W1 in the circumferential direction of the conductor part 16B fitted to stator core 26 in a convex-concave shape is set to be smaller than the width dimension W2 in the circumferential direction of a convex fitting part 26A. Thus, according to the stater 14 of the motor of the fourth embodiment, compared to the stator 14 of the motor of the third embodiment, an effect in which a magnetic gap G1 between the magnet 18 and the stator core 26 is shortened. Thus, the motor output can be improved.

### Fifth Embodiment

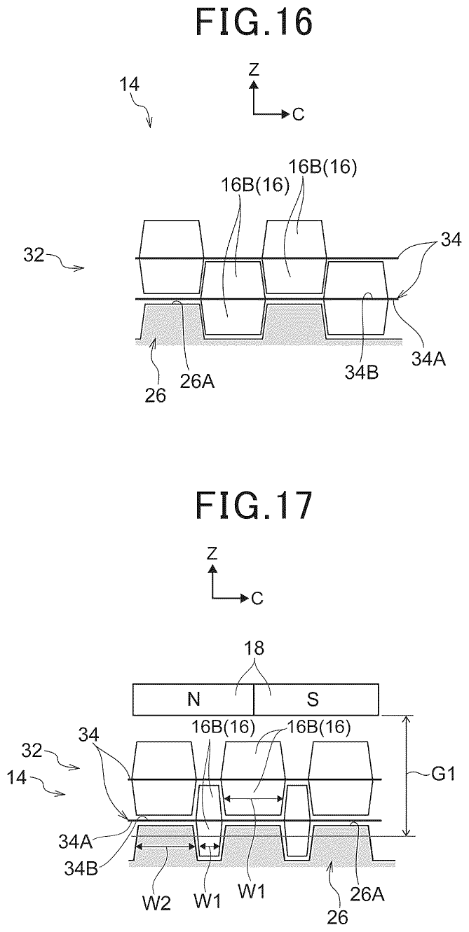

With reference to FIG. 16, a motor according to the fifth embodiment will be described. In the motor according to the fifth embodiment, the same reference symbols as those of the above-described motor 10 are applied to configurations corresponding to above-described motor 10 and the explanation thereof may be omitted.

FIG. 16 is a schematic diagram showing a cross section of a stator 14 of a motor according to a fifth embodiment, sectioned along an axial direction and a circumferential direction. As shown in FIG. 16, the configuration of the coil body 32 that constitutes a part of the stator 14 is similar to the configuration of the coil body 32 of the motor 10 according to the above-described first embodiment. Further, the configuration of the stator core 26 that constitutes a part of the stator 14 is similar to the configuration of the stator core 26 of the motor according to the above-described third embodiment.

Also, according to the stator 14 of the motor of the above-described fifth embodiment, effects and advantages similar to those obtained from the stator 14 of the motor of the above-described third embodiment can be obtained.

### Sixth Embodiment

With reference to FIG. 17, a motor according to the sixth embodiment will be described. In the motor according to the sixth embodiment, the same reference symbols as those of the above-described motor 10 are applied to configurations corresponding to above-described motor 10 and the explanation thereof may be omitted.

FIG. 17 is a schematic diagram showing a cross section of a stator 14 of a motor according to a sixth embodiment, sectioned along an axial direction and a circumferential direction. As shown in FIG. 17, according to the coil body 32 that constitutes a part of the stator 14, the width dimension W1 in the circumferential direction of the conductor part 16B at the closest portion to the stator core 26 on the substrate 34 is set to be smaller than the width dimension W1 in the circumferential direction of the conductor parts 16B formed on other substrates 34. Further, the configuration of the stator core 26 that constitutes a part of the stator 14 is similar to the configuration of the stator core 26 of the motor in the above-described fourth embodiment.

Also, according to the stator 14 of the motor of the above-described sixth embodiment, effects and advantages similar to those obtained from the stator 14 of the motor of the above-described fourth embodiment can be obtained.

### Seventh Embodiment

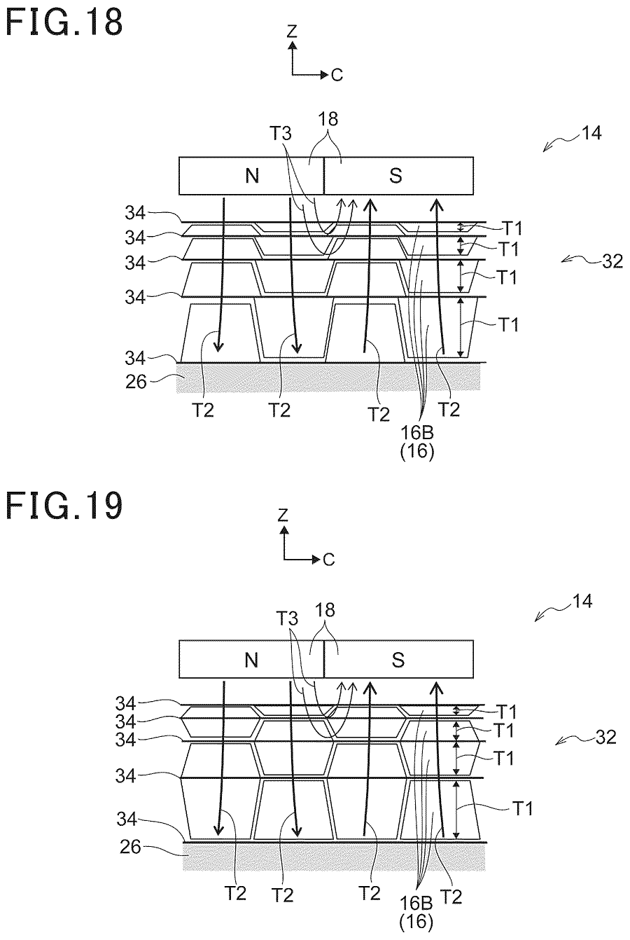

With reference to FIG. 18, a motor of a seventh embodiment will be described. In the motor according to the seventh embodiment, the same reference symbols as those of the above-described motor 10 are applied to configurations corresponding to above-described motor 10 and the explanation thereof may be omitted.

FIG. 18 is a schematic diagram showing a cross section of a stator 14 of a motor according to a seventh embodiment, sectioned along an axial direction and a circumferential direction. As shown in FIG. 18, the configuration of the coil body 32 that constitutes a part of the stator 14 is similar to the configuration of the coil body 32 of the motor according to the above-described second embodiment except configurations described below.

According to the coil body 32 of the motor of the present embodiment, a thickness dimension T1 of the conductor part 16B formed on the substrate 34 provided at a layer in a magnet 18 side is set to be smaller than a thickness dimension of the conductor part 16B formed on the substrate 34 provided in a layer opposite to the magnet 18 side. Note that the thickness dimension T1 of the conductor part 16B refers to a dimension of the conductor part 16B in a direction (axial direction) where the coil body 32 and the magnet 18 face each other.

According to the coil body 32 of the motor of the present embodiment, 5 substrates 34 are stacked in the axial direction. Here, 5 substrates 34 are referred to as a first layer substrate 34, a second layer substrate 34, a third layer substrate 34, a fourth layer substrate 34 and a fifth layer substrate 34 in the order from the stator core 26 side to the magnet 18 side.

The thickness dimension T1 of the conductor part 16B provided between the second layer substrate 34 and the third layer substrate 34 is set to be smaller than the thickness dimension T1 of the conductor part 16B provided between the first layer substrate 34 and the second layer substrate 34. Also, the thickness dimension T1 of the conductor part 16B provided between the third layer substrate 34 and the fourth layer substrate 34 is set to be smaller than the thickness dimension T1 of the conductor part 16B provided between the second layer substrate 34 and the third layer substrate 34. Moreover, the thickness dimension T1 of the conductor part 16B provided between the fourth layer substrate 34 and the fifth layer substrate 34 is set to be smaller than the thickness dimension T1 of the conductor part 16B provided between the third layer substrate 34 and the fourth layer substrate 34. Here, an arrow T2 indicated in FIG. 18 shows an interlinkage flux, and an arrow T3 shows a leakage flux. The thickness dimension T1 of the conductor part 16B formed on the substrate 34 provided at a layer in the magnet 18 side to which the leakage flux T3 interlinks in the circumferential direction, is set to be smaller, thereby reducing an eddy current loss. Further, the thickness dimension T1 of the conductor part 16B formed on the substrate 34 in a layer opposite to the magnet 18 having less interlinkage flux in the circumferential direction, is set to be larger, whereby so-called DCR loss (dc current resistance loss) can be reduced.

### Eighth Embodiment

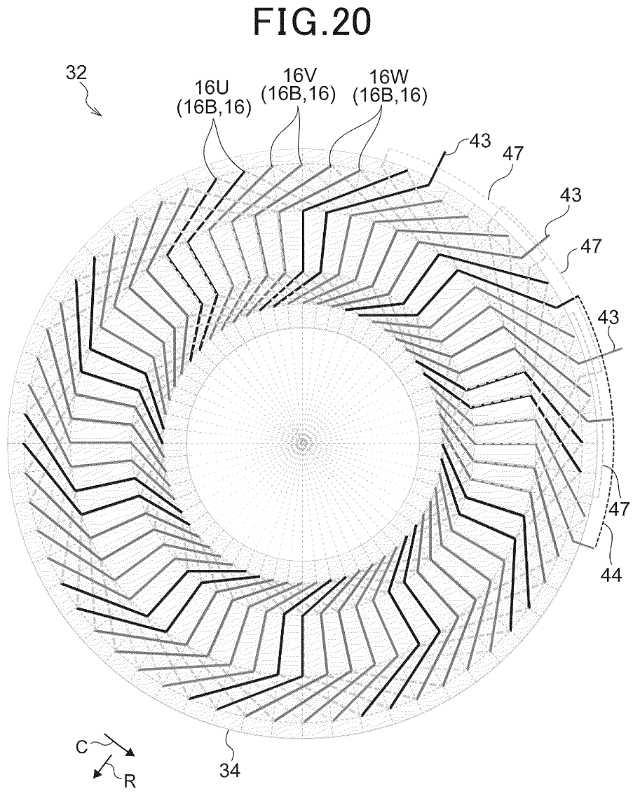

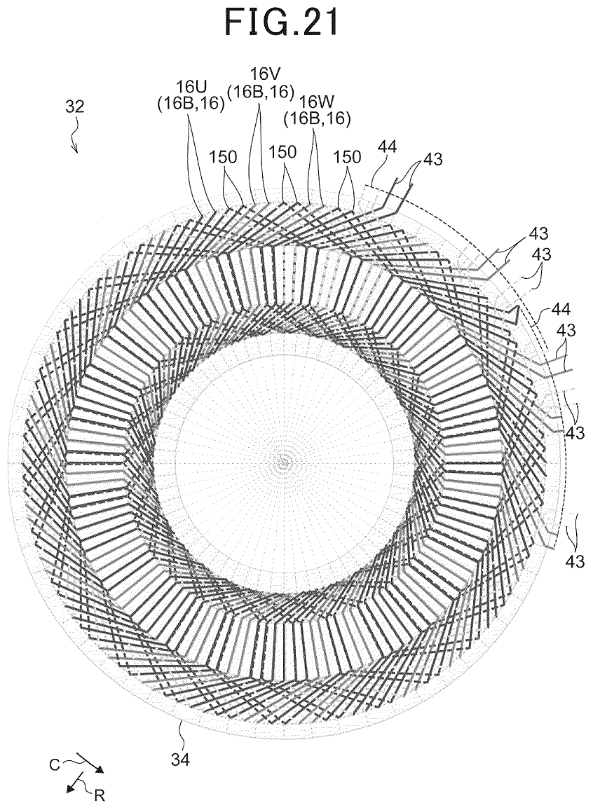

With reference to FIG. 19, a motor of an eighth embodiment will be described. In the motor according to the eighth embodiment, the same reference symbols as those of the above-described motor 10 are applied to configurations corresponding to above-described motor 10 and the explanation thereof may be omitted.

FIG. 19 is a schematic diagram showing a cross section of a stator 14 of a motor according to an eighth embodiment, sectioned along an axial direction and a circumferential direction. As shown in FIG. 19, a fundamental configuration of the coil body 32 that constitutes a part of the stator 14 is the same as that of the coil body 32 of the motor 10 according to the above-described first embodiment. Moreover, according to the coil body 32 of the motor of the present embodiment, the thickness dimension T1 of each conductor part 16B is set to be the same as that of the coil body 32 of the motor according to the above-described seventh embodiment.

Also, with the coil body 32 of the motor according to the above-described present embodiment, effects and advantages similar to those obtained from the coil body 32 of the motor of the above-described seventh embodiment can be obtained.

### Nineth Embodiment

With reference to FIG. 20, a motor of a ninth embodiment will be described. In the motor according to the ninth embodiment, the same reference symbols as those of the above-described motor 10 are applied to configurations corresponding to above-described motor 10 and the explanation thereof may be omitted.

FIG. 20 corresponds to FIG. 4 used for an explanation of the motor 10 according to the first embodiment. As shown in FIG. 4, the coil body 32 of a motor according to the present embodiment has a configuration same as that of the coil body 32 of the motor according to the first embodiment. According to the coil body 32 of the motor of the present embodiment, a plurality of coil parts 16 in U-phase formed on the first layer substrate 34 and a plurality of coil parts 16 in U-phase formed on the second layer substrate 34 are connected via a connection wire 47. Also, a plurality of coil parts 16 in V-phase formed on the first layer substrate 34 and a plurality of coil parts 16 in V-phase formed on the second layer substrate 34 are connected via a connection wire 47. Moreover, a plurality of coil parts 16 in W-phase formed on the first layer substrate 34 and a plurality of coil parts 16 in W-phase formed on the second layer substrate 34 are connected via a connection wire 47. Thus, the coil body 32 of a motor according to the present embodiment, compared to the coil body 32 of the motor 10 according to the first embodiment, an effect of an increase in the number of turns can be obtained.

### Tenth Embodiment

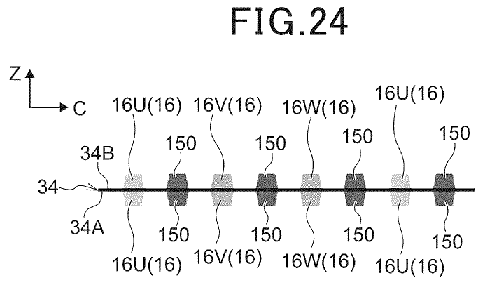

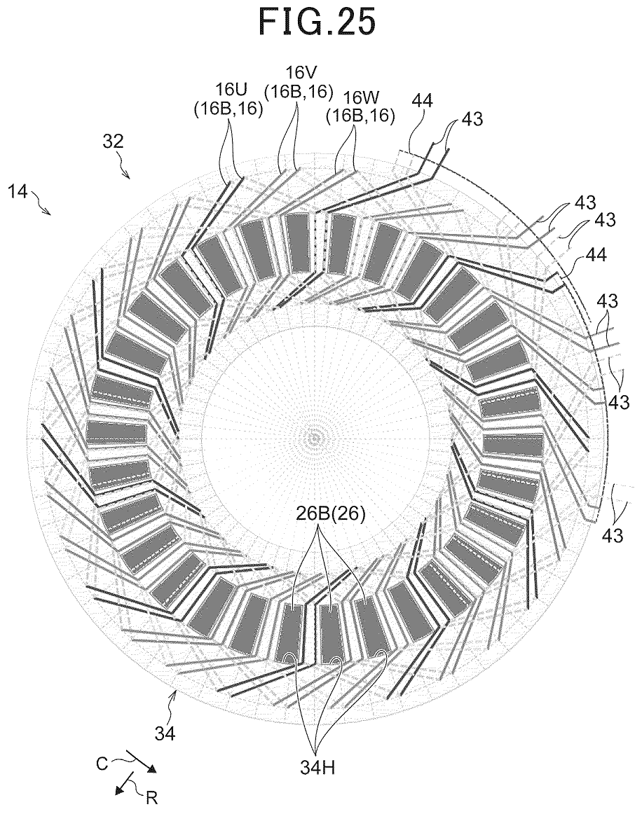

With reference to FIGS. 21 to 24, a motor of the tenth embodiment will be described. In the motor according to the ninth embodiment, the same reference symbols as those of the above-described motor 10 are applied to configurations corresponding to above-described motor 10 and the explanation thereof may be omitted.

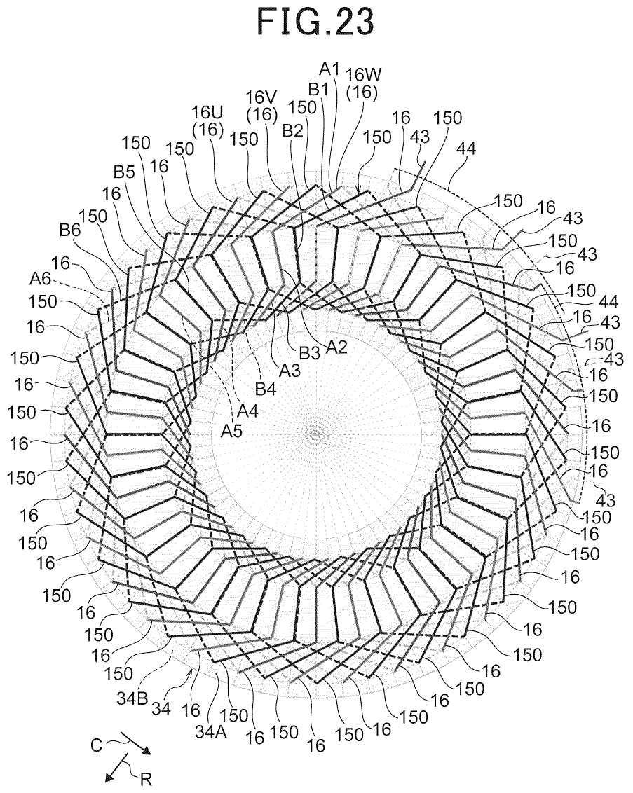

As shown in FIGS. 21 to 24, the coil body 32 according to the present embodiment has a feature of a soft magnetic member 150 as a magnetic body formed on the substrate 34. Note that FIGS. 21 and 23 correspond to FIGS. 4 and 6 respectively as a reference used for describing the motor 10 according to the first embodiment.

FIG. 23 shows a first layer substrate 34, a plurality of coil parts 16 formed on the substrate 34, a plurality of soft magnetic members 150 formed on the substrate 34. The soft magnetic members 150 are formed on the substrate 34 using a soft magnetic material, having the same pattern as that of the coil part 16. Note that current does not flow through the soft magnetic member 150 unlike the coil part 16.

In more detail, the soft magnetic member 150 is provided with a first extending part B1 inclined radially inside towards the circumferential one side, and a second extending part B2 extending from the circumferential one side of the first extending part B1 towards radially inside. Moreover, the soft magnetic member 150 is provided with a third extending member B3 inclined radially inside towards a circumferential one side from an end part of the second extending part B2 opposite to the first extending part B1, and a fourth extending part B4 inclined radially outside towards a circumferential one side from an end part of the third extending part B3 opposite to the second extending part B2. Furthermore, the soft magnetic member 150 is provided with a fifth extending member B5 extending from an end part of the fourth extending part B4 opposite to the third extending part B3 towards radially outside, and a sixth extending part B6 inclined radially outside towards a circumferential one side from an end part of the fifth extending part B5 opposite to the fourth extending part B4.

Here, the first extending part B1, the second extending part B2 and the third extending part B3 are formed on a surface 34B (surface in the stator core 26 side) as one side surface of the substrate 34. The fourth extending part B4, the fifth extending part B5 and the sixth extending part B6 are formed on a surface 34B (surface opposite to the stator core 26 side) as the other side surface of the substrate 34. The third extending part B3 and the fourth extending part B4 are electrically connected via a via contact or a through hole (not shown), for example. In FIG. 23, a portion in the soft magnetic member 150 formed on the surface 34B as one side surface of the substrate 34 is indicated by a solid line, and a portion in the soft magnetic member 150 formed on the surface 34B as the other side surface of the substrate 34 is indicated by a dotted line.

Then, the first extending part B1, the second extending part B2 and the third extending part B3 in respective soft magnetic members 150 are arranged between the first extending part A1, the second extending part A2 and the third extending part A3 of one coil part 16, and the first extending part A1, the second extending part A2 and the third extending part A3 of the other coil part 16, which are adjacently positioned in the circumferential direction. Further, the fourth extending part B4, the fifth extending part B5 and the sixth extending part B6 in respective soft magnetic members 150 are arranged between the fourth extending part A4, the fifth extending part A5 and the sixth extending part A6 of one coil part 16, and the fourth extending part A4, the fifth extending part A5 and the sixth extending part A6 of the other coil part 16, which are adjacently positioned in the circumferential direction.

The configurations of the second layer substrate 34 overlapped with the first layer substrate 34, a plurality of coil parts 16 formed on the second layer substrate 34 and a plurality of soft magnetic members 150 formed on the second layer substrate 34 are the same as the configurations of the first layer substrate 34, a plurality of coil parts 16 formed on the first layer substrate 34 and a plurality of soft magnetic members 150 formed on the first layer substrate 34.

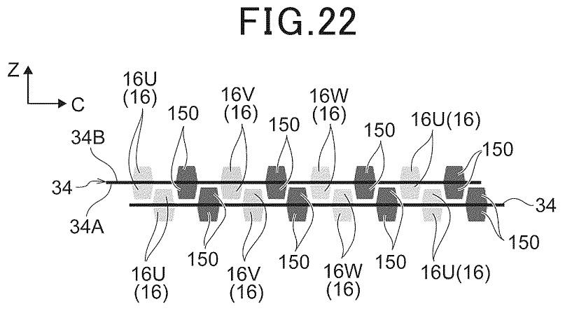

FIGS. 21 and 22 schematically show a state where the first layer substrate 34 and the second layer substrate 34 are overlapped with each other. As shown in FIGS. 21 and 22, respective parts of the coil part 16 formed on the first layer substrate 34 and respective parts of the coil part 16 formed on the second layer substrate 34 are alternately arranged in the circumferential direction and overlapped in the circumferential direction. Also, respective parts of the soft magnetic member 150 formed on the first layer substrate 34 and respective parts of the soft magnetic members 150 formed on the second layer substrate 34 are alternately arranged in the circumferential direction and overlapped in the circumferential direction.

Also with the configuration of the coil body 32 according to the above-described present embodiment, the space factor can be increased. Thus, high efficiency and high torque of the motor can be accomplished while preventing the size of the motor from increasing. Moreover, according to the stator 14 configured including the coil body 32 of the present embodiment, respective soft magnetic members 150 can be served as a teeth portion.

### Eleventh Embodiment

With reference to FIGS. 25 to 27, a motor according to the eleventh embodiment will be described. In the motor according to the eleventh embodiment, the same reference symbols as those of the above-described motor 10 are applied to configurations corresponding to above-described motor 10 and the explanation thereof may be omitted.

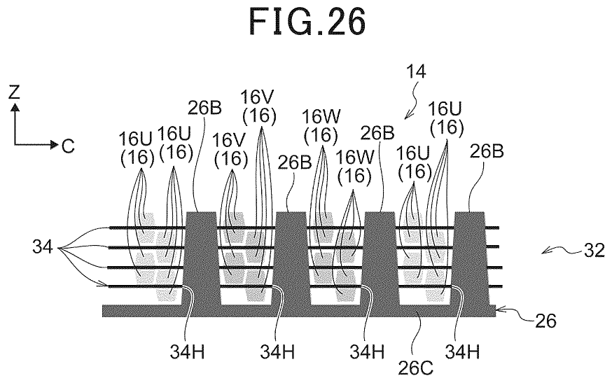

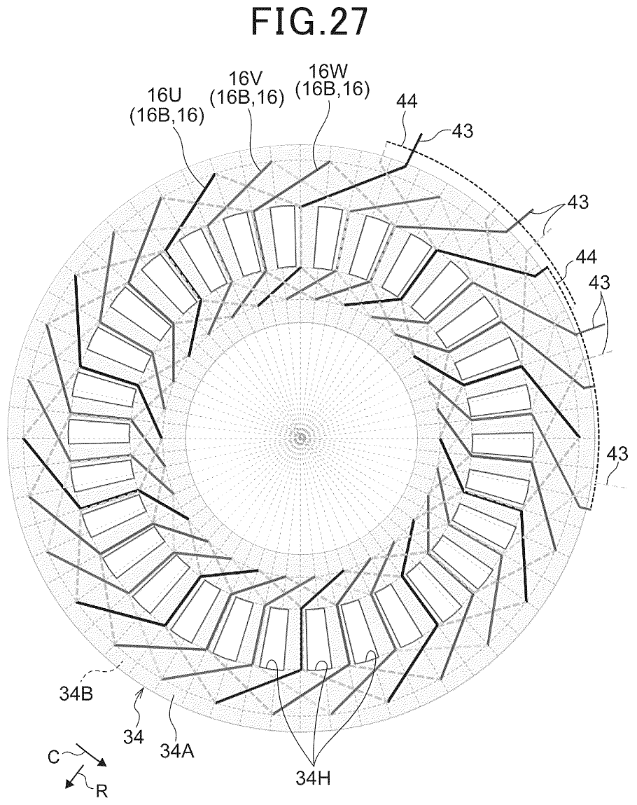

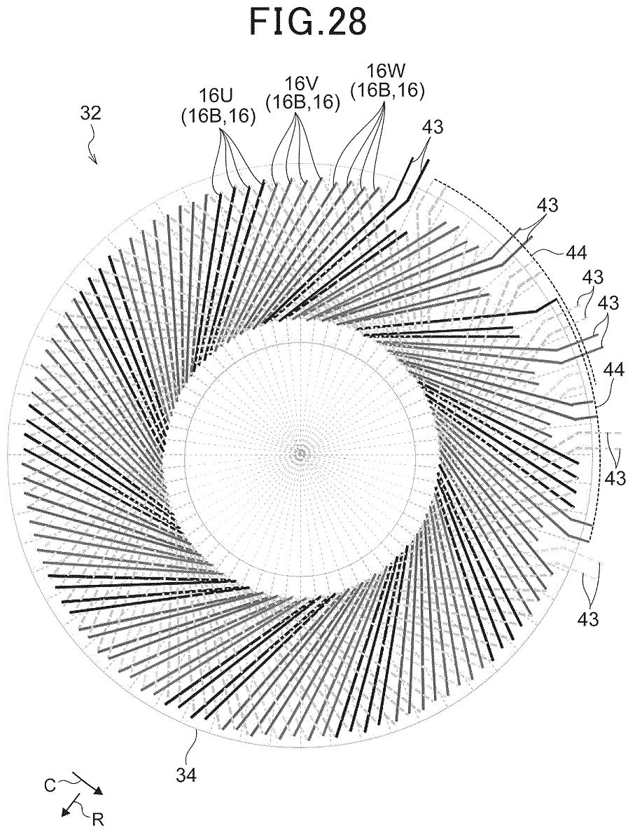

As shown in FIGS. 25 and 26, the stator 14 of a motor according to the present embodiment has a feature in which a plurality of tooth parts 26B formed in the stator core 26 are inserted into a plurality of substrates 34 that constitute a part of the coil body32. Note that FIG. 25 and FIG. 27 used for latter description correspond to FIGS. 4 and 6 respectively as a reference used for describing the motor 10 according to the first embodiment.

In more detail, the stator core 26 is provided with an annular part 26C formed in a plate shape of which the axial direction is its thickness direction and formed in an annular shape when viewed in the axial direction, and a plurality of tooth parts 26B protruding towards a coil body 32 side (axial one side) from the annular part 26C, arranged in the circumferential direction at the same intervals. The plurality of tooth parts 26B are each formed in a rectangular parallelepiped. Moreover, the shape of each tooth part 26B when viewed in the axial one side thereof is rectangular of which the longitudinal direction corresponds to the radial direction.

FIG. 27 shows a first layer substrate 34 and a plurality of coil parts 16 formed on the first layer substrate 34. As shown in FIG. 27, a plurality of teeth insertion holes 34H (see FIG. 25) are formed on the first layer substrate 34. The number of plurality of teeth insertion holes 34H corresponds to the number of tooth parts 26B. The shape of each tooth part insertion hole 34H is rectangular of which the longitudinal direction corresponds to the radial direction when viewed in the axial one side. Note that a plurality of teeth insertion holes 34H are also formed on the substrate 34 of other layers similar to those of the first layer substrate 34.

Then, in a state where the plurality of tooth parts 26B are each inserted into corresponding one of a plurality of teeth insertion holes 34H formed on the plurality of substrates 34, the coil body 32 is supported by the stator coil 26.

Similarly, with the col body 32 of the stator 14 according to the present embodiment, the space factor can be increased. Thus, high efficiency and high torque of the motor can be accomplished while preventing the size of the motor from increasing. Moreover, according to the stator 14 of the present embodiment, the plurality of tooth parts 26B are each inserted into corresponding one of the plurality of teeth insertion holes 34H, whereby the coil body 32 can be prevented from being moved in the circumferential direction with respect to the stator core 26.

### Twelfth Embodiment

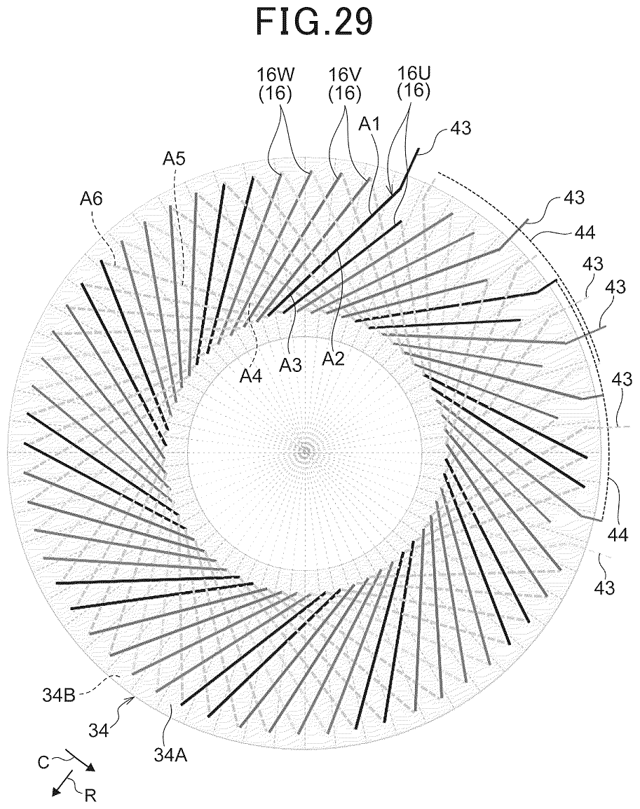

With reference to FIGS. 28 and 29, a motor of the twelfth embodiment will be described. In the motor according to the twelfth embodiment, the same reference symbols as those of the above-described motor 10 are applied to configurations corresponding to above-described motor 10 and the explanation thereof may be omitted.

Note that FIGS. 28 and 29 correspond to FIGS. 4 and 6 respectively as a reference used for describing the motor 10 according to the first embodiment. As shown in FIGS. 28 and 29, the coil body 32 of the motor according to the present embodiment is configured similar to the motor 10 of the above-described first embodiment, except that a portion of the coil part 16 corresponding to the first extending part A1, the second extending part A2 and the third extending part A3 is a linear shape, and a portion of the coil part 16 corresponding to the forth extending part A4, the fifth extending part A5 and the sixth extending part A6 is a linear shape. With the coil body 32 of the stator 14 according to the present embodiment, the space factor can be increased. Thus, high efficiency and high torque of the motor 10 can be accomplished while preventing the size of the motor from increasing.

### Thirteenth Embodiment

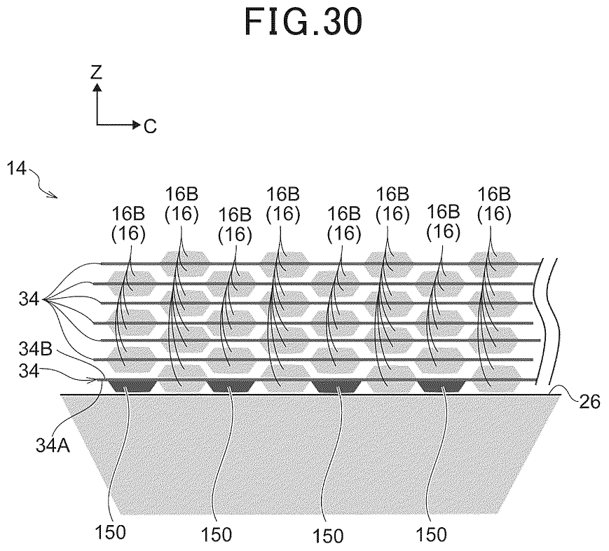

With reference to FIG. 30, a motor of the thirteenth embodiment will be described. In the motor according to the thirteenth embodiment, the same reference symbols as those of the above-described motor 10 are applied to configurations corresponding to above-described motor 10 and the explanation thereof may be omitted.

FIG. 30 corresponds to FIG. 8 used for describing the motor 10 of the first embodiment. As shown in FIG. 30, a stator 14 of a motor according to the present embodiment is configured similar to the stator 14 of the motor 10 according to the first embodiment, except that soft magnetic members 150 are formed on the first layer substrate 34 provided in a portion which is closest to the stator core 26 side. The soft magnetic members 150 are formed on one side surface 34A of the substrate 34. Then, the conductor parts 16B of the coil parts 16 and the soft magnetic members 150 are alternately arranged in the circumferential direction on the one side surface 34A of the first layer substrate 34.

Also with the stator 14 of the motor according to the present embodiment, the soft magnetic members 150 can be caused to function as a tooth part similar to the stator 14 of the motor of the above-descried tenth embodiment.

### Fourteenth Embodiment

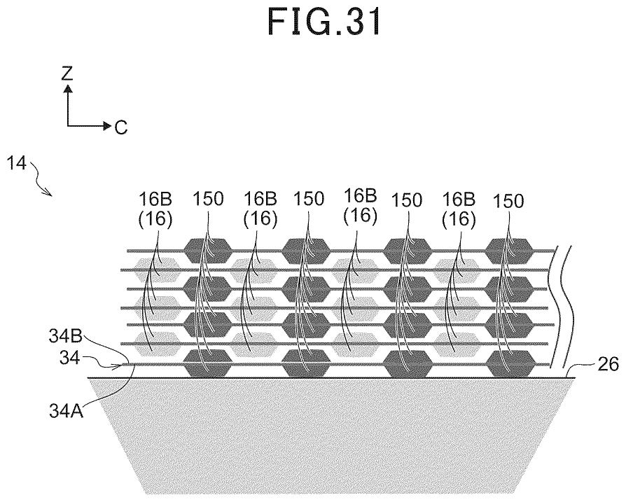

With reference to FIG. 31, a motor according to the fourteenth embodiment will be described. In the motor according to the fourteenth embodiment, the same reference symbols as those of the above-described motor 10 are applied to configurations corresponding to above-described motor 10 and the explanation thereof may be omitted.

FIG. 31 corresponds to FIG. 8 used for describing the motor 10 of the first embodiment. As shown in FIG. 31, a stator 14 of a motor according to the present embodiment is configured similar to the stator 14 of the motor 10 according to the first embodiment, except that the conductor parts 16B of the coil parts 16 formed on the substrate 34 in an odd number layer from the stator core 26 side is replaced by the soft magnetic member 150. According to the stator 14 of the motor of the present embodiment, respective soft magnetic members 150 formed on one layer substrate 34 and respective soft magnetic members 150 formed on other substrates 34 are arranged at the same position in the circumferential direction. Thus, respective soft magnetic members 150 formed on one layer substrate 34 and respective soft magnetic members 150 formed on other substrates 34 are stacked in the axial direction.

Also with the stator 14 of the motor according to the present embodiment, the soft magnetic members 150 can be caused to function as a tooth part similar to the stator 14 of the motor of the above-descried tenth embodiment.

### Fifteenth Embodiment

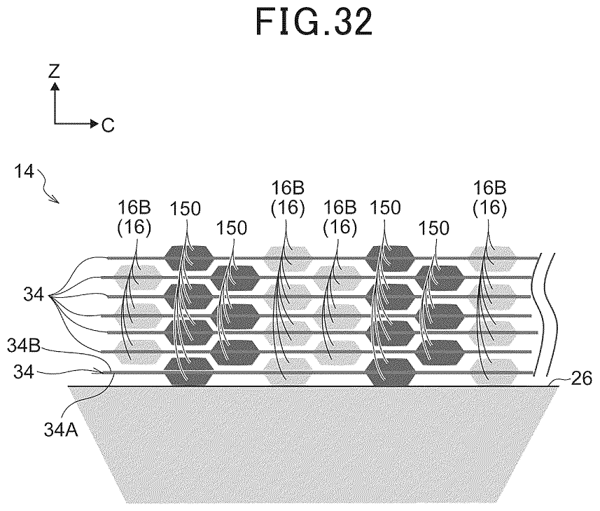

With reference to FIG. 32, a motor according to the fifteenth embodiment will be described. In the motor according to the fifteenth embodiment, the same reference symbols as those of the above-described motor 10 are applied to configurations corresponding to above-described motor 10 and the explanation thereof may be omitted.

FIG. 32 corresponds to FIG. 31 used for describing the motor of the fourteenth embodiment. As shown in FIG. 32, a stator 14 of a motor according to the present embodiment is configured similar to the stator 14 of the motor 10 according to the first embodiment, except that some of the conductor parts 16B of the coil parts 16 formed on the substrate 34 in an even number layer from the stator core 26 side are replaced by the soft magnetic members 150. According to the stator 14 of the present embodiment, respective soft magnetic members 150 formed on one odd layer substrate 34 and respective soft magnetic members 150 formed on other odd layer substrates 34 are arranged at the same position in the circumferential direction. Further, according to the stator 14 of the present embodiment, respective soft magnetic members 150 formed on one even layer substrate 34 and respective soft magnetic members 150 formed on other even layer substrates 34 are arranged at the same position in the circumferential direction. Furthermore, respective soft magnetic members 150 formed on an odd layer substrate 34 and respective soft magnetic members 150 formed on an even layer substrate 34 are adjacently arranged in the circumferential direction.

Also with the stator 14 of the motor according to the present embodiment, the soft magnetic members 150 can be caused to function as a tooth part similar to the stator 14 of the motor of the above-descried tenth embodiment.

### Sixteenth Embodiment

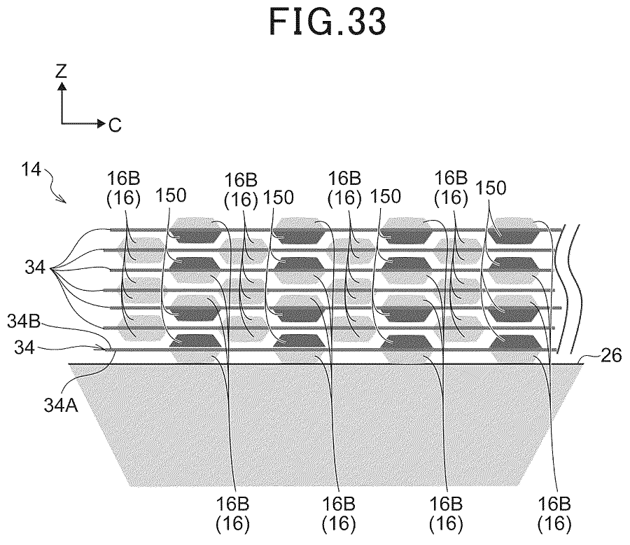

With reference to FIG. 33, a motor according to the sixteenth embodiment will be described. In the motor according to the sixteenth embodiment, the same reference symbols as those of the above-described motor 10 are applied to configurations corresponding to above-described motor 10 and the explanation thereof may be omitted.

FIG. 33 corresponds to FIG. 8 used for describing the motor 10 of the first embodiment. As shown in FIG. 33, a stator 14 of a motor according to the present embodiment is configured similar to the stator 14 of the motor 10 according to the first embodiment, except that some of the conductor parts 16B of the coil part 16 formed on the substrate 34 in an odd number layer from the stator core 26 side are replaced by the soft magnetic members 150. Also, the stator 14 of the motor according to the present embodiment is configured such that the conductor parts 16B of the coil parts 16 formed on the other surface 34B of the first and fifth layer substrates 23 are replaced by the soft magnetic members 150. Moreover, according to the stator 14 of the motor of the present embodiment, conductor parts 16B of the coil parts 16 formed on one side surface 34A of the third and seventh layer substrates 34 are replaced by the soft magnetic members 150.

Also with the stator 14 of the motor according to the present embodiment, the soft magnetic members 150 can be caused to function as a tooth part similar to the stator 14 of the motor of the above-descried tenth embodiment.

### Seventeenth Embodiment

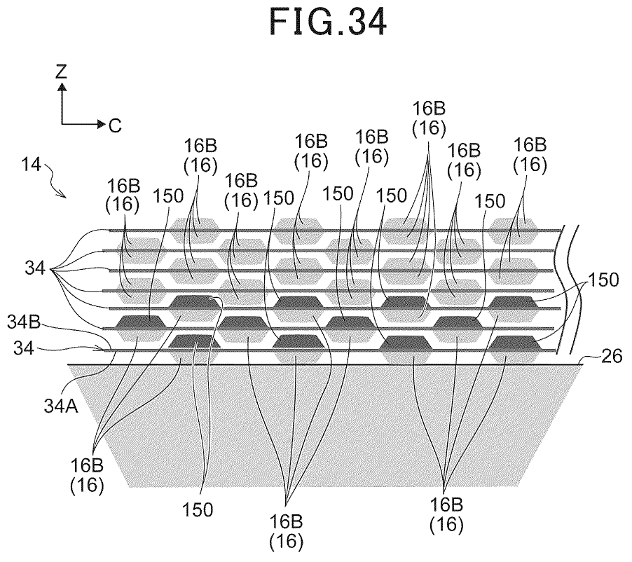

With reference to FIG. 34, a motor according to the seventeenth embodiment will be described. In the motor according to the seventeenth embodiment, the same reference symbols as those of the above-described motor 10 are applied to configurations corresponding to above-described motor 10 and the explanation thereof may be omitted.

FIG. 34 corresponds to FIG. 8 used for describing the motor 10 of the first embodiment. As shown in FIG. 34, a stator 14 of a motor according to the present embodiment is configured similar to the stator 14 of the motor 10 according to the first embodiment, except that some of the conductor parts 16B of the coil parts 16 formed on the substrates 34 in the first to third layers from the stator core 26 side are replaced by the soft magnetic members 150. According to the stator 14 of the motor of the present embodiment, the conductor parts 16B of the coil parts 16 formed on the other surface 34B of the first to third layer substrates 34 are replaced by the soft magnetic members 150.

Also with the stator 14 of the motor according to the present embodiment, the soft magnetic members 150 can be caused to function as a tooth part similar to the stator 14 of the motor of the above-described tenth embodiment.

### Eighteenth Embodiment

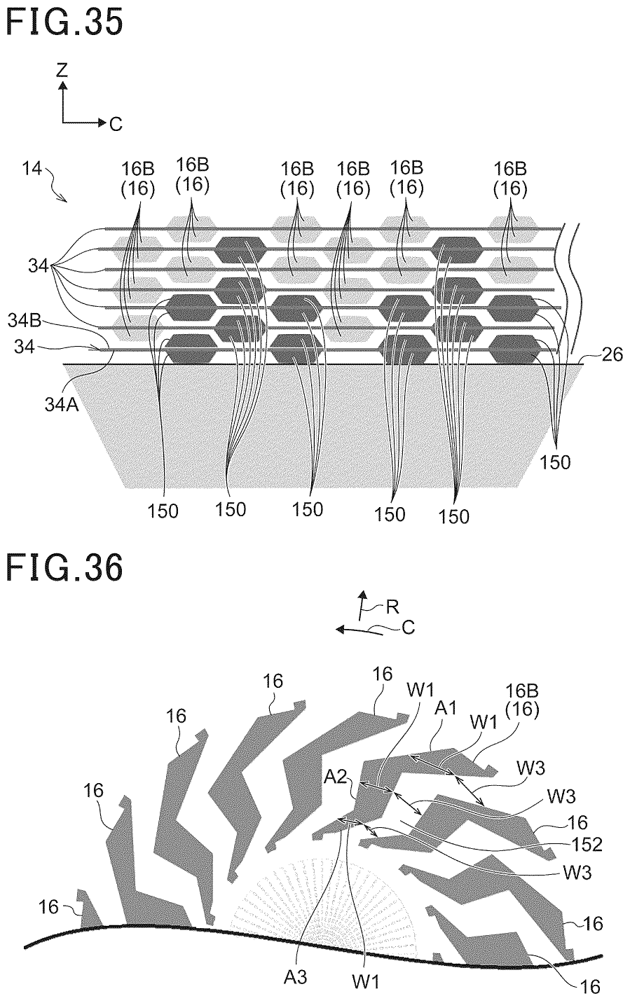

With reference to FIG. 35, a motor according to the eighteenth embodiment will be described. In the motor according to the eighteenth embodiment, the same reference symbols as those of the above-described motor 10 are applied to configurations corresponding to above-described motor 10 and the explanation thereof may be omitted.

FIG. 35 corresponds to FIG. 8 used for describing the motor 10 of the first embodiment. As shown in FIG. 35, the stator 14 of a motor according to the present embodiment is configured similar to the stator 14 of the motor 10 of the first embodiment, except that some or all of conductor parts 16B of the coil parts 16 formed on the substrates 34 in the first, second, third, fourth and sixth layers from the stator core 26 side, are replaced by the soft magnetic members 150. According to the stator 4 of the motor of the present embodiment, all of the conductor parts 16B of the coil parts 16 formed on the substrates 34 in the first and third layers are replaced by the soft magnetic members 150. Moreover, according to the stator 14 of the motor of the present embodiment, some of the conductor parts 16B of the coil parts 16 formed on the substrates 34 in the second, fourth and sixth layers are replaced by the soft magnetic members 150. The soft magnetic members 150 formed on the substrates 34 in the first and third layers are stacked in the axial direction, and the soft magnetic members 150 formed on the substrates 34 in the second, fourth and sixth layers are stacked in the axial direction. Moreover, the soft magnetic members 150 formed on the substrates 34 in the first and third layers are arranged in both sides in the circumferential direction with respect to the soft magnetic members 150 formed on the substrates 34 in the second, fourth and sixth layers.

Also with the stator 14 of the motor according to the present embodiment, the soft magnetic members 150 can be caused to function as a tooth part similar to the stator 14 of the motor of the above-descried tenth embodiment.

### Nineteenth Embodiment

With reference to FIG. 36, a motor according to the nineteenth embodiment will be described. In the motor according to the nineteenth embodiment, the same reference symbols as those of the above-described motor 10 are applied to configurations corresponding to above-described motor 10 and the explanation thereof may be omitted.

FIG. 36 shows only a coil part 16 formed on one side surface 34A of a substrate 34 in one layer constituting a coil body 32 of a motor according to the nineteenth embodiment. As shown in FIG. 36, according to the present embodiment, the width dimension W1 of a radially outside portion of the conductor part 16B in the circumferential direction is set to be larger than the width dimension W1 of a radially inside portion of the conductor part 16B in the circumferential direction. Moreover, a gap 152 is formed between conductor parts 16B adjacently positioned in the circumferential direction, in which the width dimension W3 of a radially outside potion of the gap 152 in the circumferential direction is set to be larger than the width dimension W3 of a radially inside potion of the gap 152 in the circumferential direction.

In more detail, a width dimension W1 in the circumferential direction of a first extending part A1 constituting a radially outside portion of the conductor part 16B is set to be larger than a width dimension W1 in the circumferential direction of a third extending part A3 constituting a radially inside portion of the conductor part 16B. Further, a width dimension W1 in the circumferential direction of a first extending part A1 constituting a radially outside portion of the conductor part 16B is set to be larger than a width dimension W1 in the circumferential direction of a second extending part A2 constituting an intermediate part of the conductor part 16B in the radial direction. Further, a width dimension W1 in the circumferential direction of a second extending part A2 constituting an intermediate part of the conductor part 16B in the radial direction is set to be larger than a width dimension W1 in the circumferential direction of a third extending part A3 constituting a radially inside portion of the conductor part 16B. Note that a width dimension W1 refers to a dimension from an end part of circumferential one side to an end part of the other side in the circumferential direction of a cross-section of the conductor part 16B sectioned along the axial direction and the circumferential direction. Furthermore, the width dimension W1 of the first extending part A1 in the circumferential direction becomes larger towards radially outside. Also, the width dimension W1 of the second extending part A2 in the circumferential direction becomes larger towards radially outside. The width dimension W1 of the third extending part A3 in the circumferential direction becomes larger radially outward.

Also, the width dimension W3 in the circumferential direction of the gap 152 between the first extending parts A1 of the conductor parts 16B adjacently positioned in the circumferential direction, is larger than the width dimension W3 in the circumferential direction of the gap 152 between the third extending parts A3 of the conductor parts 16B adjacently positioned in the circumferential direction. Moreover, the width dimension W3 in the circumferential direction of the gap 152 between the first extending parts A1 of the conductor parts 16B adjacently positioned in the circumferential direction, is larger than the width dimension W3 in the circumferential direction of the gap 152 between the second extending parts A2 of the conductor parts 16B adjacently positioned in the circumferential direction. Further, the width dimension W3 in the circumferential direction of the gap 152 between the second extending parts A2 of the conductor parts 16B adjacently positioned in the circumferential direction, is larger than the width dimension W3 in the circumferential direction of the gap 152 between the third extending parts A3 of the conductor parts 16B adjacently positioned in the circumferential direction. The width dimension W3 in the circumferential direction of the gap 152 between the first extending parts A1 of the conductor parts 16B adjacently positioned in the circumferential direction becomes larger towards radially outside. Also, the width dimension W3 in the circumferential direction of the gap 152 between the second extending parts A2 of the conductor parts 16B adjacently positioned in the circumferential direction becomes larger towards radially outside. Moreover, the width dimension W3 in the circumferential direction of the gap 152 between the third extending parts A3 of the conductor parts 16B adjacently positioned in the circumferential direction becomes larger towards radially outside.

Although illustration is omitted, the width dimension W1 in the circumferential direction of the sixth extending part A6 constituting a radially outside portion of the conductor part 16B is set to be larger than the width dimension W1 in the circumferential direction of the fourth extending part A4 constituting a radially inside portion of the conductor part 16B. Moreover, the width dimension W1 in the circumferential direction of the sixth extending part A6 constituting a radially outside portion of the conductor part 16B is set to be larger than the width dimension W1 in the circumferential direction of the fifth extending part A5 constituting a radially intermediate portion of the conductor part 16B. Further, the width dimension W1 in the circumferential direction of the fifth extending part A5 constituting a radially intermediate portion of the conductor part 16B is set to be larger than the width dimension W1 in the circumferential direction of the fourth extending part A4 constituting a radially inside portion of the conductor part 16B. The width dimension W1 in the circumferential direction of the sixth extending part A6 becomes larger towards radially outside. The width dimension W1 in the circumferential direction of the fifth extending part A5 becomes larger towards radially outside. Also, the width dimension W1 in the circumferential direction of the fourth extending part A4 becomes larger towards radially outside.

Further, the width dimension W3 in the circumferential direction of the gap 152 between the sixth extending parts A6 of the conductor parts 16B adjacently positioned in the circumferential direction, is larger than the width dimension W3 in the circumferential direction of the gap 152 between the fourth extending parts A4 of the conductor parts 16B adjacently positioned in the circumferential direction. Moreover, the width dimension W3 in the circumferential direction of the gap 152 between the sixth extending parts A6 of the conductor parts 16B adjacently positioned in the circumferential direction, is larger than the width dimension W3 in the circumferential direction of the gap 152 between the fifth extending parts A5 of the conductor parts 16B adjacently positioned in the circumferential direction. Further, the width dimension W3 in the circumferential direction of the gap 152 between the fifth extending parts A5 of the conductor parts 16B adjacently positioned in the circumferential direction, is larger than the width dimension W3 in the circumferential direction of the gap 152 between the fourth extending parts A4 of the conductor parts 16B adjacently positioned in the circumferential direction. Also, the width dimension W3 in the circumferential direction of the gap 152 between the sixth extending parts A6 of the conductor parts 16B adjacently positioned in the circumferential direction becomes larger towards radially outside. The width dimension W3 in the circumferential direction of the gap 152 between the fifth extending parts A5 of the conductor parts 16B adjacently positioned in the circumferential direction becomes larger towards radially outside. Similarly, width dimension W3 in the circumferential direction of the gap 152 between the fourth extending parts A5 of the conductor parts 16B adjacently positioned in the circumferential direction becomes larger towards radially outside.

As described above, according to the present embodiment, the width dimension W1 of a radially outside portion of the conductor part 16B in the circumferential direction is set to be larger than the width dimension of a radially inside portion of the conductor part 16B in the circumferential direction. Thus, compared to a case where the width dimension W1 of a radially outside portion of the conductor part 16B in the circumferential direction is set to be the same as the width dimension W1 of a radially inside portion of the conductor part 16B in the circumferential direction, the space factor of the coil body 32 can be improved.

### Twentieth Embodiment

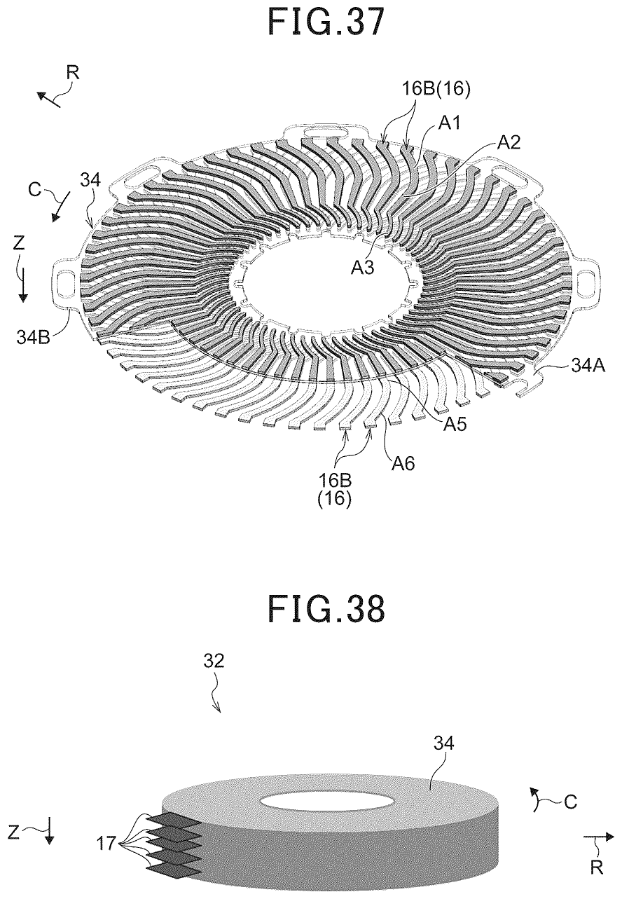

With reference to FIG. 37, a motor according to the twentieth embodiment will be described. In the motor according to the twentieth embodiment, the same reference symbols as those of the above-described motor 10 are applied to configurations corresponding to above-described motor 10 and the explanation thereof may be omitted.

FIG. 37 illustrates a substrate 34 in one layer constituting a part of a coil body 32 of a motor according to a twentieth embodiment and a coil part 16 formed on the substrate 34. As shown in FIG. 37, according to the present embodiment, conductors in an area from the first extending parts A1 to the second extending part A2 constituting a part of the conductor part 16B is formed in a shape along an involute curve when viewed in an axial direction. Also, conductors in an area from the sixth extending parts A6 to the fifth extending part A5 constituting a part of the conductor part 16B is formed in a shape along an involute curve when viewed in an axial direction. Thus, compared to a case where the above-descried part in the conductor 16B formed in a shape not being along an involute curve, the space factor of the coil body 32 can be improved.

### Twenty first Embodiment

With reference to FIG. 38, a motor according to the twenty first embodiment will be described. In the motor according to the twenty first embodiment, the same reference symbols as those of the above-described motor 10 are applied to configurations corresponding to above-described motor 10 and the explanation thereof may be omitted.

FIG. 38 is a perspective view schematically showing a coil body 32. As shown in FIG. 38, according to the present embodiment, connection parts 17 protrudes towards radially outside from respective stacked substrates 34. These connection parts 17 are concentrated at the same portion in the circumferential direction and arranged in the axial direction. The connection parts 17 refer to a part connected to respective coil parts 16 formed on the substrate 34. For example, they are the above-described input part 43 or the neutral point 44. According to the present embodiment, these connection parts 17 are concentrated at one portion in the circumferential direction and arranged in the axial direction, whereby connection between respective connection parts 17 can readily be accomplished. Note that these connection parts 17 may be mutually offset in the circumferential direction.

The present disclosure has been described in accordance with the embodiments. However, the present disclosure is not limited to the above-described embodiments.

The present disclosure may be modified and embodied in various manners without departing from the spirit of the present disclosure. Further, all of or a part of configurations in the above-described embodiments may be mutually combined.

For example, configurations may be appropriately selected depending on usage of the motor 10 or the like. The configuration of the motor 10 or the like may be applied to a generator. Moreover, the configuration of the motor 10 or the like may be applied to an outer-rotor type brushless motor in which a rotor 12 is disposed in a radially outside portion of the stator 14. Furthermore, the configuration of the present disclosure may be applied to a rotor configured including the coil body 32.

### Appendix

### (Appendix1)

A coil body (32) comprising:
a base member (34) formed in a shape extending in a radial direction using an insulation material, stacked in an axial direction;
a plurality of conductor parts (16B) each formed on the base material using a conductive material, arranged along a circumferential direction; and
a plurality of coil parts (16) configured such that the conductor parts formed on one layer of the base member and the conductor parts formed on other layers of the base member are alternately arranged in the circumferential direction, and the plurality of conductor parts formed on one layer of the base member and the plurality of conductor parts formed on other layers of the base member are overlapped in the circumferential direction.

### (Appendix 2)

The coil body according to appendix 1, wherein
a configuration is provided in which a plurality of the coil parts formed on the base member in one layer and a plurality of the coil parts formed on the base member in other layers adjacently positioned to the one layer in the axial direction; and
a pattern of the plurality of coil parts formed on the base member in one layer and a pattern of the plurality of the coil parts formed on the base member in other layers are matched.

### (Appendix 3)

The coil body according to appendix 1 or 2, wherein
a configuration is provided in which a plurality of the coil parts formed on the base member in one layer and a plurality of the coil parts formed on the base member in other layers adjacently positioned to the one layer in the axial direction; and
a width dimension (W1) of the conductor parts in the circumferential direction formed on the base member in one layer becomes smaller towards the base member in other layers; and
a width dimension of the conductor parts in the circumferential direction formed on the base member in other layers becomes smaller towards the base member in one layer.

### (Appendix 4)

The coil body according to any one of appendixes 1 to 3 further comprising a plurality of magnetic bodies (150) each formed on the base member using a soft magnetic material, arranged along a circumferential direction.

### (Appendix 5)

The coil body according to any one of appendixes 1 to 4, wherein
a gap is formed between conductor parts adjacently positioned in the circumferential direction on the base member in one layer; and
a width dimension in the circumferential direction of a radially outside portion of the gap is set to be larger than a width dimension in the circumferential direction of a radially inside portion of the gap.

### (Appendix 6)

The coil body according to any one of appendixes 1 to 5, wherein
connection parts (17) connected to a plurality of coil parts are provided, each protruding from the base member in one layer and the base members in other layers; and
the connection parts protruding from the base member in one layer and the base members in other layers are arranged in the axial direction.

### (Appendix 7)

The coil body according to any one of appendixes 1 to 6, wherein
a part of the plurality of coil parts constitutes the coil part in one phase; another part of the plurality of coil parts constitutes the coil part in another phase; and the conductor parts of the coil part in the same phase are arranged in the axial direction.

### (Appendix 8)

A coil body (32) comprising:
a base member (34) formed in a shape extending in a radial direction using an insulation material, stacked in an axial direction;
a plurality of coil parts (16) including a plurality of conductor parts (16B) each formed on the base material using a conductive material, arranged along a circumferential direction; and
a plurality of magnetic bodies (150) each formed on the base member using a soft magnetic material, wherein
the magnetic bodies formed on the base member in one layer and the magnetic bodies formed on the base member in other layers are at the same position in the circumferential direction.

### (Appendix 9)

An armature unit (14) provided with the coil body according to any one of appendixes 1 to 8.

### (Appendix 10)

The armature unit according to appendix 9 further comprising an armature core (26) formed in an annular shape using a soft magnetic member, wherein
the coil body is disposed along the armature core; and
the conductor parts formed on the base member disposed at a layer facing the armature core and the armature core are fitted in a convex-concave shape.

### (Appendix 11)

The armature unit according to appendix 9 further comprising an armature core (26) formed in an annular shape using a soft magnetic member, wherein
the coil body is disposed along the armature core; and
the conductor parts formed on the base member disposed at a layer facing the armature core and a convex portion formed on the armature core are fitted in a convex-concave shape; and
a width dimension in a circumferential of the conductor parts facing the armature core being fitted in a convex-concave shape, is set to be smaller than a width dimension in the circumferential direction of the convex portion of the armature core.

### (Appendix 12)

The armature unit according to appendix 9 further comprising an armature core (26) formed in an annular shape using a soft magnetic member, wherein
a plurality of tooth parts (26B) are formed on the armature core, protruding towards the coil body;
the base member includes a plurality of teeth insertion holes (34H) formed thereon to which the plurality of tooth parts are inserted;

### (Appendix 13)

A rotary electric machine (10) provided with one of either a stator (14) or a rotor (12) which are configured including an armature unit according to any one of appendixes 9 to 12 and the other one of the stator or the rotor which includes a magnet (18) disposed facing the coil body in the axial direction.

### (Appendix 14)

The rotary electric machine according to appendix 13, wherein
defining a dimension of the conductor part in an axial direction where the coil body and the magnet face each other to be a thickness dimension (T1),
the thickness dimension of the conductor part formed on the base member provided at a layer in a magnet side is set to be smaller than a thickness dimension of the conductor part formed on the base member provided in a layer opposite to the magnet.

The present disclosure has been described in accordance with the embodiments. However, the present disclosure is not limited to the embodiments and structure thereof. The present disclosure includes various modification examples and modifications within the equivalent configurations. Further, various combinations and modes and other combinations and modes including one element or more or less elements of those various combinations are within the range and technical scope of the present disclosure.

### Conclusion

An object of the present disclosure is to accomplish high efficiency and higher torque for a coil body, an armature and a rotary electric machine, while reducing the size thereof.

According to a first aspect of the present disclosure, a coil body is provided with a base member formed in a shape extending in a radial direction using an insulation material, stacked in an axial direction; a plurality of conductor parts each formed on the base material using a conductive material, arranged along a circumferential direction; and a plurality of coil parts configured such that the conductor parts formed on one layer of the base member and the conductor parts formed on other layers of the base member are alternately arranged in the circumferential direction, and the plurality of conductor parts formed on one layer of the base member and the plurality of conductor parts formed on other layers of the base member are overlapped in the circumferential direction.

Also, the coil body includes: a base member formed in a shape extending in a radial direction using an insulation material, stacked in an axial direction; a plurality of coil parts including a plurality of conductor parts each formed on the base material using a conductive material, arranged along a circumferential direction; and a plurality of magnetic bodies each formed on the base member using a soft magnetic material, wherein the magnetic bodies formed on the base member in one layer and the magnetic bodies formed on the base member in other layers are at the same position in the circumferential direction.

Further, the armature unit includes the above-described coil body. A rotary electric machine is provided with one of either a stator or a rotor which are configured including the above-described armature unit and the other one of the stator or the rotor which includes a magnet disposed facing the coil body in the axial direction.

According to the above-described configuration, higher efficiency and higher torque can be accomplished while reducing the size thereof.

What is claimed is:

1. A coil body comprising:
a base member formed in a shape extending in a radial direction using an insulation material, stacked in an axial direction;
a plurality of conductor parts each formed on the base material using a conductive material, arranged along a circumferential direction; and
a plurality of coil parts configured such that the conductor parts formed on one layer of the base member and the conductor parts formed on other layers of the base member are alternately arranged in the circumferential direction, and the plurality of conductor parts formed on one layer of the base member and the plurality of conductor parts formed on other layers of the base member are overlapped in the circumferential direction.

2. The coil body according to claim 1, wherein
a configuration is provided in which a plurality of the coil parts formed on the base member in one layer and a plurality of the coil parts formed on the base member in other layers are adjacently positioned to the one layer in the axial direction; and
a pattern of the plurality of coil parts formed on the base member in one layer and a pattern of the plurality of the coil parts formed on the base member in other layers are matched.

3. The coil body according to claim 1, wherein
a configuration is provided in which a plurality of the coil parts formed on the base member in one layer and a plurality of the coil parts formed on the base member in other layers are adjacently positioned to the one layer in the axial direction; and
a width dimension of the conductor parts in the circumferential direction formed on the base member in one layer becomes smaller towards the base member in other layers; and
a width dimension of the conductor parts in the circumferential direction formed on the base member in other layers becomes smaller towards the base member in the one layer.

4. The coil body according to claim 1 further comprising a plurality of magnetic bodies each formed on the base member using a soft magnetic material, arranged along a circumferential direction.

5. The coil body according to claim 1, wherein
a gap is formed between conductor parts adjacently positioned in the circumferential direction on the base member in one layer; and
a width dimension in the circumferential direction of a radially outside portion of the gap is set to be larger than a width dimension in the circumferential direction of a radially inside portion of the gap.

6. The coil body according to claim 1, wherein
connection parts connected to a plurality of coil parts are provided, each protruding from the base member in one layer and the base members in other layers; and
the connection parts protruding from the base member in one layer and the base members in other layers are arranged in the axial direction.

7. The coil body according to claim 1, wherein
a part of the plurality of coil parts constitutes the coil part in one phase;
another part of the plurality of coil parts constitutes the coil part in another phase; and
the conductor parts of the coil part in the same phase are arranged in the axial direction.

8. A coil body comprising:
a base member formed in a shape extending in a radial direction using an insulation material, stacked in an axial direction;
a plurality of coil parts including a plurality of conductor parts each formed on the base material using a conductive material, arranged along a circumferential direction; and
a plurality of magnetic bodies each formed on the base member using a soft magnetic material, wherein
the magnetic bodies formed on the base member in one layer and the magnetic bodies formed on the base member in other layers are at the same position in the circumferential direction.

9. An armature unit provided with a coil body, the coil body comprising:
a base member formed in a shape extending in a radial direction using an insulation material, stacked in an axial direction;
a plurality of conductor parts each formed on the base member using a conductive material, arranged along a circumferential direction; and
a plurality of coil parts configured such that the conductor parts formed on one layer of the base member and the conductor parts formed on other layers of the base member are alternately arranged in the circumferential direction, and the plurality of conductor parts formed on the one layer of the base member and the plurality of conductor parts formed on other layers of the base member are overlapped in the circumferential direction.

10. The armature unit according to claim 9 further comprising an armature core formed in an annular shape using a soft magnetic member, wherein
the coil body is disposed along the armature core; and
the conductor parts formed on the base member disposed at a layer facing the armature core and the armature core are fitted in a convex-concave shape.

11. The armature unit according to claim 9 further comprising an armature core formed in an annular shape using a soft magnetic member, wherein
the coil body is disposed along the armature core; and
the conductor parts formed on the base member disposed at a layer facing the armature core and a convex portion formed on the armature core are fitted in a convex-concave shape; and
a width dimension in a circumferential of the conductor parts facing the armature core being fitted in a convex-concave shape, is set to be smaller than a width dimension in the circumferential direction of the convex portion of the armature core.

12. The armature unit according to claim 9 further comprising an armature core formed in an annular shape using a soft magnetic member, wherein
a plurality of tooth parts are formed on the armature core, protruding towards the coil body;
the base member includes a plurality of teeth insertion holes formed thereon to which the plurality of tooth parts are inserted;

13. A rotary electric machine provided with one of either a stator or a rotor which are configured including an armature unit and the other one of the stator or the rotor which includes a magnet disposed facing the coil body in the axial direction, wherein
the armature unit is provided with a coil body comprising:
a base member formed in a shape extending in a radial direction using an insulation material, stacked in an axial direction;
a plurality of conductor parts each formed on the base member using a conductive material, arranged along a circumferential direction; and
a plurality of coil parts configured such that the conductor parts formed on one layer of the base member and the conductor parts formed on other layers of the base member are alternately arranged in the circumferential direction, and the plurality of conductor parts formed on one layer of the base member and the plurality of conductor parts formed on other layers of the base member are overlapped in the circumferential direction.

14. The rotary electric machine according to claim 13, wherein
defining a dimension of the conductor part in an axial direction where the coil body and the magnet face each other to be a thickness dimension,
the thickness dimension of the conductor part formed on the base member provided at a layer in a magnet side is set to be smaller than a thickness dimension of the conductor part formed on the base member provided in a layer opposite to the magnet.
